(19) United States
(12) Patent Application Publication
(10) Pub. No.: US 2021/0122923 A1
(43) Pub. Date: Apr. 29, 2021

(54) Bio-Based Hydrophobic Formulations For Use in Engineered Wood Composites

(71) Applicant: Polymer Synergies, LLC, Mantua Township, NJ (US)

(72) Inventor: Joseph J. Marcinko, West Deptford, NJ (US)

(21) Appl. No.: 16/666,392

(22) Filed: Oct. 28, 2019

(51) Int. Cl. C08L 97/02; C08K 5/101

(52) U.S. Cl. CPC C08L 97/02; C08K 5/101

(57) ABSTRACT

The present invention is directed to a wax substitute composition comprising a vegetable alkyl ester (as exemplified by soybean methyl ester) and a polysiloxane. Such a composition can be then further used to prepare silicone-treated lignocellulose particles for use in preparing a lignocellulose composite product, comprising lignocellulose particles and the wax substitute. The vegetable alkyl ester may also be mixed with a binder resin. Further, the vegetable alkyl ester can be used with a binder resin, and a polysiloxane to prepare lignocellulose composite products. One of the advantages of the vegetable alkyl ester is that it is a good solvent for PMDI and polyurethane polymers along with being a good solvent for functionalized silicones.

### FIELD OF THE INVENTION

The present invention is directed to hydrophobic formulations for use in the preparation of or treatment of engineered wood composites.

### BACKGROUND

Lignocellulosic composite articles, such as oriented strand board (OSB), oriented strand lumber (OSL), particleboard (PB), medium density fiberboard (MDF), high density fiberboard (HDF), scrimber, fiberboard, agrifiber board, chipboard, flakeboard, and like are typically produced by blending or spraying lignocellulosic particles with a binder resin composition while the lignocellulosic particles are tumbled or agitated in a blender or similar apparatus. After blending sufficiently to form a binder-lignocellulosic mixture, the lignocellulosic particles, which are now coated with the binder resin, are formed into a product, specifically a loose mat, which is compressed between heated platens or plates to set the binder resin and to bond the lignocellulosic particles together in a densified form, such as in a board, panel, or other shape. Conventional processes for compressing the loose mat are generally carried out at temperatures of from about 120° C. to about 225° C., in the presence of varying amounts of steam, either purposefully injected into the loose mat or generated by liberation of entrained moisture from the lignocellulosic particles in the loose mat. These processes also generally require that the moisture content of the lignocellulosic particles is between about 2 wt % and about 20 wt %, before blending the lignocellulosic particles with the binder resin.

In addition to wood, the lignocellulosic particles in the form of chips, shavings, strands, scrim, wafers, fibers, sawdust, bagasse, straw, wood wool, agricultural waste fibers like wheat straw, rice straw, sugar cane bagasse, and other waste agricultural materials can also be used to make engineered lignocellulosic composites by the use of binder resins. When the lignocellulosic particles are relatively larger in size, such as 3 to 20 cm, the lignocellulosic composite articles produced by the process can be called engineered wood. These engineered woods include laminated strand lumber, OSB, OSL, scrimber, parallel strand lumber, and laminated veneer lumber. When the lignocellulosic particles are relatively smaller, such as typical sawdust and refined fiber sizes, the lignocellulosic composite articles are particleboard (PB) and fiberboard (e.g., MDF). Other engineered woods, such as plywood, employ larger sheets of lumber, which are held together by a binder resin in a sandwich configuration. Yet other engineered woods, such as scrimber, employ thin, long, irregular particles of wood having average diameters ranging from about 2 to 10 mm and lengths several meters in length.

The engineered woods were developed because of the increasing scarcity of suitably sized tree trunks for cutting lumber. Such engineered woods can have advantageous physical properties such as strength and stability. Another advantage of the engineered woods is that they can be made from the waste material generated by processing other wood and lignocellulosic materials. This leads to efficiencies and energy savings from the recycling process and saves landfill space.

Binder resins that have been used for making such lignocellulosic composite articles include isocyanate resins, phenol formaldehyde (PF) resins, urea formaldehyde (UF) resins, melamine urea formaldehyde (MUF) and sometimes bio-based adhesives based on soy protein or hybrid versions of bio-based adhesives which combine protein sources and one of the standard wood composite binder resins. Binder resins based on isocyanate chemistry are commercially desirable because they have low water absorption, high adhesive and cohesive strength, flexibility in formulation, versatility with respect to cure temperature and rate, excellent structural properties, the ability to bond with lignocellulosic materials having high water contents, and importantly, zero formaldehyde emissions. Lignocellulosic composite articles utilizing such binder resins are imparted with corresponding properties/benefits.

Lignocellulosic materials can be treated with polymethylene poly(phenyl isocyanates), also known as polymeric MDI or pMDI, to improve the strength of the composite article. Typically, such treatment involves applying the isocyanate to the lignocellulosic material and allowing the isocyanate to cure, either by application of heat and pressure or at room temperature. While it is possible to allow the pMDI to cure under ambient conditions, residual isocyanate (NCO) groups remain on the treated articles for weeks or even months in some instances. Toluene diisocyanate (TDI) can also be utilized for such purposes but is generally less acceptable from an environmental standpoint. Isocyanate prepolymers are among the preferred isocyanate materials that have been used in binder resins to solve various processing problems, particularly, in reducing adhesion to press platens and for reducing reactivity of the isocyanates.

Aside from the binder resin, the engineered wood formulation typically comprises a wax. Wax is used in engineered composites to reduce water uptake and to reduce swelling of the composite. The waxes used in engineered wood formulations are typically petroleum-based. Due to perceived environmental impacts of petroleum products, supplies of these waxes are uncertain, and their costs have risen dramatically in the past few years. There has been a movement to find suitable substitutes for petroleum-based waxes.

Possible substitutes for waxes include diverse compositions, such as silicones, fluorine-containing compounds, and other hydrophobic components. Such substitutes for wax are viable and are very efficient, but are expensive. Such substitutes are best utilized at very low application loadings, in the range of 0.1 wt % to 0.5 wt % based on the dry weight of wood. The low application loadings make it difficult to efficiently apply these materials and get sufficient surface coverage of all the wood or lignocellulosic particles.

There is a need for hydrophobic silicone fluid dispersed or soluble in an appropriate carrier solvent that does not interfere with the adhesion of the binder resins and also that does not contribute to water ingress into the composite.

Release agents are disclosed in U.S. Pat. No. 7,018,461. The reference provides release agents and methods for preparing textiles and molded articles therefrom. Lignocellulosic materials, concrete and polyurethane foam can be molded with these release agents. The release agents comprise the salt of tall oil fatty acids, preferably of very high purity. A synthetic wax and/or silicone resin is used with the tall oil fatty acids in preferred embodiments. The tall oil fatty acids contain less than 10 wt %, based on the total weight of the tall oil fatty acid, of unsaponifiables and less than 1 wt %, based on the total weight of the tall oil fatty acid, of rosin acid.

Transesterification of vegetable oils with ethanol and characterization of the key fuel properties of ethyl esters were disclosed in G. Anastopoulos et al. Energies 2009, vol. 2, pp 362-376.

Binder compositions and methods for making and using the same are disclosed in U.S. Pat. No. 9,815,928. Binder compositions and methods for making and using same are provided. In at least one specific embodiment, the binder composition can include at least one unsaturated compound having two or more unsaturated carbon-carbon bonds and at least one free-radical precursor. At least one of the unsaturated carbon-carbon bonds can be a pi-bond that is not conjugated with an aromatic moiety and can be capable of free radical addition. The free radical precursor can be present in an amount of about 7 wt % to about 99 wt %, based on the weight of the one or more unsaturated compounds.

Co-adhesive system for bonding wood, fibers, or agriculture based composite materials is disclosed in U.S. Pat. No. 5,607,633. The reference provides an adhesive system comprising a blend of resin and a co-adhesive conjugated triglyceride, which is especially well suited to bonding composite panels such as oriented strand board, particle board, plywood, MDF, hardboard, and similar panels. The resin is a fast acting bonding material which forms a mat of fibers into a self sustaining panel within a time limit during which a press may be economically utilized. The triglyceride acts slower so that, after the panel is formed, there is enough time to penetrate the fibers to a depth that results in a superior bonding.

Protein adhesives containing an anhydride, carboxylic acid, and/or carboxylate salt compound and their use is disclosed in U.S. Pat. No. 9,873,823. That disclosure provides protein adhesives, and methods of making and using such adhesives. The protein adhesives contain a protein-bonding agent and plant protein composition, such as an isolated water-soluble protein fraction or ground plant meal obtained from plant biomass. The protein-bonding agent can be an anhydride compound, carboxylic acid compound, carboxylate salt compound, or combinations thereof. The protein adhesives are useful in bonding together lignocellulosic materials and other types of materials.

Compositions that include hydrophobizing agents and stabilizers and methods for making and using same are taught in U.S. Pat. No. 9,404,221. Compositions that include hydrophobizing agents and stabilizers and methods for making and using same are provided. In at least one specific embodiment, a composition can include about 40 wt % to about 60 wt % lignosulfonic acid or a salt thereof, about 1 wt % to about 20 wt % of a hydrophobizing agent, and about 20 wt % to about 59 wt % of a liquid medium, where all weight percents are based on the combined weight of the lignosulfonic acid or salt thereof, the hydrophobizing agent, and the liquid medium.

Protein-containing adhesives, and manufacture and use thereof are discussed in U.S. Pat. No. 10,125,295. That reference provides protein adhesives and methods of making and using such adhesives. One type of protein adhesive described contains lignin and ground plant meal or an isolated polypeptide composition obtained from plant biomass. Other types of protein adhesives described herein contain a plant protein composition and either a hydroxyaromatic/aldehyde, urea/aldehyde, or amine/aldehyde component.

### SUMMARY OF THE INVENTION

The present invention is directed to a wax substitute composition comprising a vegetable alkyl ester and a polysiloxane. The present invention is also directed to silicone-treated lignocellulose particles for use in preparing a lignocellulose composite product, comprising lignocellulose particles and the wax substitute. The present invention is further directed a composition comprising a vegetable alkyl ester and a binder resin. Further, the present invention is directed to a composition comprising a vegetable alkyl ester, a binder resin, and a polysiloxane. Still further, the present invention is directed to a lignocellulose composite product comprising: lignocellulose particles, and a composition comprising a vegetable alkyl ester, a binder resin, and a polysiloxane.

One of the advantages of the present invention is that the vegetable C₁₋₄ alkyl ester is a good solvent for PMDI and polyurethane polymers along with being a good solvent for functionalized silicones. This means that these ingredients can be compatibilized. This advantage of mixing them the ingredients together is that it increases the volume of liquid material applied to the wood or lignocellulosic particles and which in turn has better surface coverage.

The wax substitute composition is a replacement of petroleum-based wax compound used in preparation of lignocellulose composite products. The wax substitute comprises at least two ingredients: a vegetable alkyl ester and a polysiloxane.

The vegetable alkyl ester is an ester of a vegetable oil. Further, the vegetable C₁₋₄ alkyl ester may be a mixture of vegetable alkyl esters of alkyl groups of different lengths.

Under one embodiment, the vegetable C₁₋₄ alkyl ester is a vegetable methyl ester. Vegetable C₁₋₄ alkyl ester is a fatty acid ester that is derived by transesterification of fats with C₁₋₄ alcohol.

The C₁₋₄ alkyl ester of a C₁₆₋₂₀ fatty acid may be obtained from any suitable source, including vegetable raw materials, animal fats, suet, tallow, blubber, recycled alimentary fats, starting materials produced by genetic engineering, biological starting materials produced by microbes such as algae and bacteria, or mixtures thereof

To obtain the vegetable C₁₋₄ alkyl ester, any suitable transesterification process may be employed. In the transesterification process, the added alkanol (such as methanol, ethanol, propanol, butanol, or a mixture thereof) is deprotonated with a base to make it a stronger nucleophile.

Triglycerides are reacted with an alkanol to give ethyl esters of fatty acids and glycerol by the reaction

RCOO—CH(CH₂COOR)₂+3 R^{a}OH→RCOOR^{a}+HO—CH(CH₂OH)₂

wherein each R is independently a C₁₆₋₂₀ alkyl group, and R^{a} is a C₁₋₄ alkyl group.

The C₁₋₄ alkanol reacts with the fatty acids to form a mono-alkyl ester and glycerol.

The vegetable oil maybe be derived from any appropriate source. Suitable vegetable oils are mixtures of triglycerides. Such vegetable oils are extracted from seeds or other parts of fruits.

The vegetable C₁₋₄ alkyl ester is a vegetable methyl ester, wherein the vegetable methyl ester is avocado methyl ester, canola methyl ester, coconut methyl ester, corn methyl ester, cottonseed methyl ester, flaxseed methyl ester, grape seed methyl ester, hemp seed methyl ester, linseed methyl ester, olive methyl ester, palm methyl ester, peanut methyl ester, safflower methyl ester, soybean methyl ester, sunflower methyl ester. Under one embodiment, the vegetable C₁₋₄ alkyl ester is a vegetable methyl ester, wherein the vegetable methyl ester is a mixture of any of the preceding

Under one embodiment, the vegetable C₁₋₄ alkyl ester is a vegetable methyl ester, wherein the vegetable methyl ester is soybean methyl ester.

Polysiloxane contains an inorganic silicon-oxygen backbone chain —Si—O—Si—O—Si—O— with organic side groups attached to the silicon atoms, and terminal groups. Polysiloxane comprises the repeating —[RR′SiO]—, wherein R and R′ are organic groups that may be the same or different.

Under one embodiment, the polysiloxane is polydimethylsiloxane (PDMS) of formula (CH₃)₃Si—[Si(CH₃)₂—O]ₙ—Si(CH₃)₃, wherein n is a large number.

Under one embodiment, the organic side groups link two or more of the —Si—O— backbones together. Under one embodiment, the polysiloxane is a branched polysiloxane.

The identity of the terminal group has an effect on the miscibility of the polysiloxane with the vegetable C₁₋₄ alkyl ester, and thus on the ability to perform well as a water repellant. The preferred polysiloxane is a functionalized polysiloxane. One preferred polysiloxane is comprised of at least one terminal group, or a terminal ligand, that is polar.

Examples of a functionalized polysiloxane include polysiloxanes that are terminated with one or more ligands such as halide, —Cl, —Br, aminoalkyl, —(CH₂)ₐNH₂, hydroxyl, —OH, vinyl, —CH═CH₂, glycidyl ether, —(CH₂)_{b}—O—(CH₂)_{c}—OH, —(CH₂)_{d}—O—(CH₂)ₑ-cyclo(C₂H₃O), epoxycyclohexylethyl, —(CH₂)₂—(C₆H₉O), acrylamidoalkyl, —(CH₂)_{f}—N—CO—CH═CH₂, and mixtures thereof; wherein a, b, c, d, e, and f are each independently are 0 to 3.

The functionalized polysiloxane may have one, two, or more of such ligands.

Under another embodiment, the polysiloxanes are terminated by a C₁₋₁₈ alkyl group or —(CH₂)ₕ—CH₃, wherein h=0 to 17.

The polysiloxane backbone may be substituted by various groups. The polysiloxane comprises repeating groups —[SiRR′—O]—, wherein R and R′ are each independently selected from the group consisting of hydrogen, —H, C₁₋₁₈ alkyl, —(CH₂)ᵣ—CH₃, methyl, —CH₃, -ethyl, —CH₂—CH₃, hydroxypolyalkoxyalkyl, —(CH₂)ₛ—(O(CH₂)ₜ)ᵤ—OH, phenyl, Ph, —(CH₂)ᵥ—CH(Me)Ph, and mixtures thereof, wherein r=0 to 17, and s, t, u, and v each independently are 0 to 5.

The present invention is also directed to a composition comprising a vegetable alkyl ester and a binder resin, and optionally a polysiloxane.

The binder resin can include one or more polymeric materials, homopolymeric materials, copolymeric materials, oligomeric materials, resin materials, combinations thereof, or any mixture thereof. The binder resin is typically chosen from an isocyanate component, a formaldehyde resin, a protein-based adhesive, or a combination thereof.

The binder component generally adheres to the lignocellulosic particles to one another, once cured. The isocyanate component is typically a polyisocyanate having two or more isocyanate functional groups. In certain embodiments, the isocyanate component is an isocyanate-terminated prepolymer.

The wax substitute of the present invention has many uses, including substituting for petroleum-based waxes and oils. The wax substitute of the present invention may be used as a substitute for mineral oils, other oils. Under one embodiment, the mixture of vegetable C₁₋₄ alkyl ester and polysiloxane may be used as a wax substitute in preparation of engineer wood composites.

Under one embodiment, the mixture of the vegetable C₁₋₄ alkyl ester and polysiloxane substitutes for the wax completely. Under another embodiment, the mixture of the vegetable C₁₋₄ alkyl ester and polysiloxane substitutes for the wax partially.

The present invention is also directed to the use of the mixture of the vegetable C₁₋₄ alkyl ester and polysiloxane as the treatment of lignocellulose particles prior to the mixing of the lignocellulose particles with the binder resin.

Under one embodiment, the method for producing the lignocellulose composite product includes contacting or combining the plurality of lignocellulose particles with the composition of the vegetable C₁₋₄ alkyl ester and polysiloxane and the binder resin to produce a mixture.

A variety of lignocellulose composite products and other fiber or wood-based composite products can be made by bonding the plurality of lignocellulose particles or other fibers and/or particles, and the mixture of vegetable C₁₋₄ alkyl ester and polysiloxane. The fiber or wood-based composite products may include or be made from lignocellulose particles, cellulosic fibers, synthetic fibers.

Under one embodiment, the method for producing the lignocellulose composite product includes contacting or combining the plurality of lignocellulose particles with the composition of the vegetable C₁₋₄ alkyl ester and polysiloxane and the binder resin to produce a mixture. The binder resin in the mixture can be at least partially cured to produce the lignocellulose composite product.

The lignocellulose particles contacted with a mixture of vegetable C₁₋₄ alkyl ester and polysiloxane and a binder resin can be formed into the desired shape before, during, and/or after at least partial curing of the binder resins.

In one or more embodiments, a method for producing the lignocellulose composite product can include contacting or combining the plurality of lignocellulose particles with vegetable C₁₋₄ alkyl ester and polysiloxane mixture and binder resin to produce a mixture. Further, the lignocellulose particles, a mixture of vegetable C₁₋₄ alkyl ester and polysiloxane, and the binder resin can be combined or contacted with each other in any order or at the same time to produce the mixture. In another embodiment, a lignocellulose composite product can include the plurality of lignocellulose particles, vegetable C₁₋₄ alkyl ester and polysiloxane mixture, and one or more at least partially cured binder resins.

The lignocellulose composite product can be formed into a variety of different fiber-containing composite products, wood-containing composite products, or a mixture thereof.

The present invention is also directed to a formulation comprising the mixture of vegetable C₁₋₄ alkyl ester and binder resin for the use in porous particles. This may be used as a coating or durable protection of various porous substrates, including wood, wood products, paper, concrete, mortar, stone, open-celled foam, and like.

At least twenty-three aspects define the invention.

In the first aspect, the invention relates to a wax substitute composition comprising (a) about 5 wt % to about 95 wt % of a vegetable C₁₋₄ alkyl ester; and (b) about 5 wt % to about 95 wt % of a polysiloxane.

In the second aspect, the invention relates to a wax substitute composition comprising (a) about 5 wt % to about 95 wt % of a vegetable methyl ester; and (b) about 5 wt % to about 95 wt % of a polysiloxane.

In the third aspect, the invention relates to a wax substitute composition comprising (a) about 5 wt % to about 95 wt % of a vegetable methyl ester; and (b) about 5 wt % to about 95 wt % of a polysiloxane, wherein the vegetable methyl ester is selected from the group consisting of avocado methyl ester, canola methyl ester, coconut methyl ester, corn methyl ester, cottonseed methyl ester, flaxseed methyl ester, grape seed methyl ester, hemp seed methyl ester, linseed methyl ester, olive methyl ester, palm methyl ester, peanut methyl ester, safflower methyl ester, soybean methyl ester, sunflower methyl ester, and mixtures thereof.

In the fourth aspect, the invention relates to a wax substitute composition comprising (a) about 5 wt % to about 95 wt % of a vegetable methyl ester; and (b) about 5 wt % to about 95 wt % of a polysiloxane, wherein the vegetable methyl ester is selected from the group consisting of cottonseed methyl ester, corn methyl ester, flaxseed methyl ester, linseed methyl ester, soybean methyl ester, sunflower methyl ester, and mixtures thereof.

In the fifth aspect, the invention relates to a wax substitute composition comprising (a) about 5 wt % to about 95 wt % of a vegetable methyl ester; and (b) about 5 wt % to about 95 wt % of a polysiloxane, wherein the vegetable methyl ester is soybean methyl ester.

In the sixth aspect, the invention relates to a wax substitute composition comprising (a) about 5 wt % to about 95 wt % of a vegetable C₁₋₄ alkyl ester; and (b) about 5 wt % to about 95 wt % of a polysiloxane. wherein the polysiloxane are terminated with one or more ligands selected from the group consisting of halide, —Cl, —Br, aminoalkyl, —(CH₂)ₐNH₂, hydroxyl, —OH, vinyl, —CH═CH₂, glycidyl ether, —(CH₂)_{b}—O—(CH₂)_{c}—OH, —(CH₂)_{d}—O—(CH₂)ₑ-cyclo(C₂H₃O), epoxycyclohexylethyl, —(CH₂)₂—(C₆H₉O), acrylamidoalkyl, —(CH₂)_{f}N—CO—CH═CH₂, and mixtures thereof; wherein a, b, c, d, e, f and g each independently is 0 to 3.

In the seventh aspect, the invention relates to a wax substitute composition comprising (a) about 5 wt % to about 95 wt % of a vegetable C₁₋₄ alkyl ester; and (b) about 5 wt % to about 95 wt % of a polysiloxane, wherein the polysiloxane is terminated with one or more ligands selected from the group consisting of hydride, —H, C₁₋₁₈ alkyl, —(CH₂)ₐ—CH₃, aminoalkyl, —(CH₂)_{b}NH₂, hydroxyl, —OH, and mixtures thereof.

In the eighth aspect, the invention relates to a wax substitute composition comprising (a) about 5 wt % to about 95 wt % of a vegetable C₁₋₄ alkyl ester; and (b) about 5 wt % to about 95 wt % of a polysiloxane. wherein the polysiloxane comprises repeating groups —[SiRR′—O]—, wherein R and R′ are each independently selected from the group consisting of hydrogen, —H, C₁₋₁₈ alkyl, —(CH₂)ᵣ—CH₃, methyl, —CH₃, -ethyl, —CH₂—CH₃, hydroxyalkoxyalkyl, —(CH₂)ₛ—(O(CH₂)ₜ)ᵤ—OH, phenyl, Ph, —(CH₂)ᵥ—CH(Me)-Ph, and mixtures thereof, wherein r=0 to 17, and s, t, u, and v each independently are 0 to 5.

In the ninth aspect, the invention relates to a wax substitute composition comprising (a) about 5 wt % to about 95 wt % of a vegetable C₁₋₄ alkyl ester; and (b) about 5 wt % to about 95 wt % of a polysiloxane, wherein the polysiloxane comprises repeating groups —[SiRR′—O]—, wherein R and R′ are each independently selected from the group consisting of hydrogen, —H, C₁₋₁₈ alkyl, —(CH₂)ᵣ—CH₃,—(CH₂)ᵥ—CH(Me)-Ph, and mixtures thereof, wherein r=0 to 17, and v=0 to 5.

In the tenth aspect, the invention relates to a silicone-treated lignocellulose particles for use in preparing a lignocellulose composite product, comprising (a) about 40 wt % to about 99 wt % of lignocellulose particles and (b) about 0.1 wt % to about 60 wt % of the composition comprising (a) about 5 wt % to about 95 wt % of a vegetable C₁₋₄ alkyl ester; and (b) about 5 wt % to about 95 wt % of a polysiloxane.

In the eleventh aspect, the invention relates to a composition comprising: about 5 wt % to about 95 wt % of a vegetable C₁₋₄ alkyl ester; and about 5 wt % to about 95 wt % of a binder resin.

In the twelfth aspect, the invention relates to a composition comprising: about 5 wt % to about 95 wt % of a vegetable methyl ester; and about 5 wt % to about 95 wt % of a binder resin.

In the thirteenth aspect, the invention relates to a composition comprising: about 5 wt % to about 95 wt % of a vegetable C₁₋₄ alkyl ester; and about 5 wt % to about 95 wt % of a binder resin, wherein the vegetable methyl ester is selected from the group consisting of avocado methyl ester, canola methyl ester, coconut methyl ester, corn methyl ester, cottonseed methyl ester, flaxseed methyl ester, grape seed methyl ester, hemp seed methyl ester, linseed methyl ester, olive methyl ester, palm methyl ester, peanut methyl ester, safflower methyl ester, soybean methyl ester, sunflower methyl ester, and mixtures thereof.

In the fourteenth aspect, the invention relates to a composition comprising: about 5 wt % to about 95 wt % of a vegetable C₁₋₄ alkyl ester; and about 5 wt % to about 95 wt % of a binder resin, wherein the binder resin is selected from the group consisting of polymeric methylenediphenyl diisocyanate, PMDI, phenol formaldehyde, PF, urea formaldehyde, UF, melamine urea formaldehyde, MUF, and mixtures thereof.

In the fifteenth aspect, the invention relates to a composition comprising: about 5 wt % to about 95 wt % of a vegetable C₁₋₄ alkyl ester; and about 5 wt % to about 95 wt % of a binder resin, wherein the binder resin is polymeric methylenediphenyl diisocyanate or PMDI.

In the sixteenth aspect, the invention relates to a composition comprising: about 5 wt % to about 95 wt % of a vegetable C₁₋₄ alkyl ester; and about 5 wt % to about 95 wt % of a binder resin, further comprising about 5 wt % to about 95 wt % of a polysiloxane.

In the seventeenth aspect, the invention relates to a composition comprising: about 5 wt % to about 95 wt % of a vegetable C₁₋₄ alkyl ester; and about 5 wt % to about 95 wt % of a binder resin, further comprising about 5 wt % to about 95 wt % of a polysiloxane, wherein the polysiloxane are terminated with one or more ligands selected from the group consisting of hydride, —H, halide, —Cl, —Br, —C₁₋₁₈ alkyl, —(CH₂)ₐ—CH₃, aminoalkyl, —(CH₂)_{b}NH₂, hydroxyl, —OH, vinyl, —CH═CH₂, glycidyl ether, —(CH₂)_{c}—O—(CH₂)_{d}—OH, —(CH₂)ₑ—O—(CH₂)_{f}-cyclo(C₂H₃O), epoxycyclohexylethyl, —(CH₂)₂—(C₆H₉O), acrylamidoalkyl, —(CH₂)_{g}N—CO—CH═CH₂, and mixtures thereof; wherein a=0 to 17; and b, c, d, e, f and g each independently are 0 to 3.

In the eighteenth aspect, the invention relates to a composition comprising: about 5 wt % to about 95 wt % of a vegetable C₁₋₄ alkyl ester; and about 5 wt % to about 95 wt % of a binder resin, further comprising about 5 wt % to about 95 wt % of a polysiloxane, wherein the polysiloxane comprises repeating groups —[SiRR′—O]—, wherein R and R′ are each independently selected from the group consisting of hydrogen, —H, C₁₋₁₈ alkyl, —(CH₂)ᵣ—CH₃, methyl, —CH₃, -ethyl, —CH₂—CH₃, hydroxypolyalkoxyalkyl, —(CH₂)ₛ—(O(CH₂)ₜ)ᵤ—OH, phenyl, Ph, —(CH₂)ᵥ—CH(Me)-Ph, and mixtures thereof, wherein r=0 to 17, and s, t, u, and v each independently are 0 to 5.

In the nineteenth aspect, the invention relates to a lignocellulose composite product comprising about 80 wt % to about 98 wt % of lignocellulose particles, and about 2 wt % to about 20 wt % of composition comprising: about 5 wt % to about 95 wt % of a vegetable C₁₋₄ alkyl ester; and about 5 wt % to about 95 wt % of a binder resin, further comprising about 5 wt % to about 95 wt % of a polysiloxane.

### DETAILED DESCRIPTION OF THE INVENTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation.

As used herein and in the appended claims, the singular forms “a”, “an”, and “the” include plural references unless the context dictates otherwise. The singular form of any class of the ingredients refers not only to one chemical species within that class, but also to a mixture of those chemical species; for example, the term “solvent” in the singular form, may refer to a mixture of compounds each of which is also a solvent. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

The abbreviations and symbols as used herein, unless indicated otherwise, take their ordinary meaning. The abbreviation “wt %” means percent by weight. Unless otherwise indicated, “%” means percent by weight. The symbol “mL” refers to a milliliter or 10⁻³ liters. The symbol “cm” refers to centimeter or 10⁻² meters. The symbol “cSt” refers to a centistokes or mm²·s⁻¹. The symbol “MPa” refers to a megapascal or 10⁻⁵ bar.

The symbols “lb”, and “ft³”, “in”, and “mil” mean pound, cubic foot, inch, and thousandths of an inch, respectively. The symbol “∘” refers to a degree.

The term “about” when referring to a number means any number within a range of 10% of the number. For example, the phrase “about 40 wt %” refers to a number between and including 36.000 wt % and 44.000 wt %.

When referring to chemical structures and formulas, the symbols are given their meaning as typically used in the chemical industry. Additionally, or alternatively, when referring to chemical structures and formulas, the symbols “C”, “H”, “N”, “O”, “Si”, and “Me” mean carbon, hydrogen, nitrogen, oxygen, silicon, and methyl respectively. Additionally, or alternatively, when referring to chemical structures and formulas, the symbols “—” and “═” mean single bond, and double bond, respectively.

The abbreviations “SME”, “PDMS”, “fPDMS”, “nfPDMS”, “PMDI”, “PF”, “UF”, and “MUF” mean soy methyl ester, polydimethylsiloxane, functionalized polydimethylsiloxane, non-functionalized polydimethylsiloxane, polymeric methylene diphenyl diisocyanate, phenol formaldehyde, urea formaldehyde, and melamine urea formaldehyde, respectively.

The abbreviations “OSB”, “OSL”, PB″, “MDF”, “HDF”, “HVLP” means oriented strand board, oriented strand lumber, particleboard, medium density fiberboard, and high density fiberboards, high volume low pressure, respectively.

Phrase “dry weight of wood” or “dry wood” refer to wood that has been kiln dried. Such wood typically contains less than 10 wt % water.

As used throughout, ranges are used as shorthand for describing each and every value that is within the range. Any value within the range can be selected as the terminus of the range.

The term “mixture” is to be interpreted broadly. It refers to a solution, an emulsion, a dispersion, a mixture displaying the Tyndall effect, or any other homogeneous mixture. Under one embodiment, the mixture is shelf stable. When referring to a list of ingredients, unless specifically indicated otherwise, the term “mixture” refers to a mixture of the aforementioned ingredients with each other, a mixture of any of aforementioned ingredients with other ingredients that are not aforementioned, and to a mixture of several aforementioned ingredients with other ingredients that are not aforementioned.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

For readability purposes, the chemical functional groups are in their adjective form; for each of the adjective, the word “group” is assumed. For example, the adjective “methyl” without a nouns thereafter, should be read as “a methyl group”.

All references cited herein are hereby incorporated by reference in their entireties. In the event of a conflict in a definition in the present disclosure and that of a cited reference, the present disclosure controls.

The present invention is directed to a wax substitute composition comprising a vegetable alkyl ester and a polysiloxane.

The present invention is also directed silicone-treated lignocellulose particles for use in preparing a lignocellulose composite product, comprising lignocellulose particles and the wax substitute.

The present invention is further directed a composition comprising a vegetable alkyl ester and a binder resin.

Further, the present invention is directed to a composition comprising a vegetable alkyl ester, a binder resin, and a polysiloxane.

Still further, the present invention is directed to a lignocellulose composite product comprising: lignocellulose particles, and a composition comprising a vegetable alkyl ester, a binder resin, and a polysiloxane.

One of the advantages of the present invention is that the vegetable C₁₋₄ alkyl ester is a good solvent for PMDI and polyurethane polymers along with being a good solvent for functionalized silicones. The reason why this is important is that these materials can be mixed together. The advantage of mixing them the ingredients together is that it increases the volume of liquid material applied to the wood or lignocellulosic particles and which in turn has better surface coverage.

The wax substitute composition is a replacement of petroleum-based wax compound used in preparation of lignocellulose composite products. The wax substitute comprises at least two ingredients: a vegetable alkyl ester and a polysiloxane.

The vegetable alkyl ester is an ester of vegetable oil.

The alkyl group on the alkyl ester is a small alkyl group. Under one embodiment, the small alkyl group contains six of fewer carbons, such as methyl, ethyl, propyl, butyl, pentyl, or hexyl.

Under one embodiment, the alkyl group is a C₁₋₄ alkyl. Examples of such small alkyl groups include methyl, —CH₃, ethyl, —CH₂—CH₃, n-propyl, —(CH₂)₂—CH₃, i-propyl, —CH(CH₃)₂, n-butyl, —(CH₂)₃—CH₃, i-butyl, —CH₂—CH(CH₃)₂, s-butyl, —CHMe—CH₂—CH₃, and mixtures thereof.

Under one embodiment, the phrase “vegetable C₁₋₄ alkyl ester” includes the mixtures of the vegetable alkyl esters that comprise different C₁₋₄ alkyl ester. For example, a vegetable C₃ alkyl ester means a vegetable propyl ester, or a vegetable n-propyl ester, or vegetable i-propyl ester, or a mixture of a vegetable n-propyl ester and vegetable i-propyl ester.

Further, the vegetable C₁₋₄ alkyl ester may be a mixture of vegetable alkyl esters of alkyl groups of different lengths. For example, a 50:50 mixture of vegetable ethyl ester and vegetable propyl ester may be designated as “vegetable C_{2.5} alkyl ester”.

Under one embodiment, the vegetable C₁₋₄ alkyl ester is a vegetable methyl ester.

Vegetable C₁₋₄ alkyl ester is a fatty acid ester that is derived by transesterification of fats with C₁₋₄ alcohol. Such fatty acid esters are similar to those used in biodiesel or detergents that are typically obtained from vegetable oils by transesterification. They are used to produce detergents and biodiesel. Vegetable C₁₋₄ alkyl ester are typically produced by an alkali-catalyzed reaction between fats and alkanol in the presence of a base such as sodium hydroxide, sodium methoxide or potassium hydroxide.

The present invention is directed to a water repellent composition comprising a C₁₋₄ alkyl ester of a C₁₆₋₂₀ fatty acid, and a polysiloxane.

The C₁₋₄ alkyl ester of a C₁₆₋₂₀ fatty acid may be obtained from any suitable source, including vegetable raw materials, animal fats, suet, tallow, blubber, recycled alimentary fats, starting materials produced by genetic engineering, biological starting materials produced by microbes such as algae and bacteria, or mixtures thereof. Condensation products, esters, or other derivatives obtained from biological raw materials may also be used as starting materials.

To obtain the vegetable C₁₋₄ alkyl ester, any suitable transesterification process may be employed. In the transesterification process, the added alkanol (such as methanol, ethanol, propanol, butanol, or a mixture thereof) is deprotonated with a base to make it a stronger nucleophile. Typically, a catalyst may be used to speed the reaction. Common catalysts for transesterification include sodium hydroxide, NaOH, potassium hydroxide, KOH, sodium methoxide, CH₃O⁻Na⁺, or mixtures thereof.

Vegetable C₁₋₄ alkyl ester may be produced from virgin vegetable oils using base-catalyzed techniques using commercially available processes with low temperatures and pressures to producing over 90% conversion yield. Yields may be improved by lowering the moisture and free fatty acid content.

Triglycerides are reacted with an alkanol to give ethyl esters of fatty acids and glycerol by the reaction

RCOO—CH(CH₂COOR)₂+3 R^{a}OH→RCOOR^{a}+HO—CH(CH₂OH)₂

wherein each R is independently a C₁₆₋₂₀ alkyl group, and R^{a} is a C₁₋₄ alkyl group.

The C₁₋₄ alkanol reacts with the fatty acids to form a mono-alkyl ester and glycerol. The reaction between the oil and the alcohol is a reversible reaction, thus excess alcohol may be added to ensure complete conversion

Any suitable production method may be used to obtain the vegetable C₁₋₄ alkyl ester from the corresponding vegetable oil. To produce the vegetable C₁₋₄ alkyl ester, under one embodiment, a catalyst-free method for transesterification using supercritical alkanol at high temperatures and pressures in a continuous process is used. In the supercritical state, the oil and alkanol are in a single phase, and a reaction occurs spontaneously and rapidly.

Under another embodiment, the vegetable C₁₋₄ alkyl ester is produced using high-shear or ultra-high-shear in-line and batch reactors. The reaction takes place in the high-energetic shear zone of the high-shear or ultra-high-sheer mixer by reducing the droplet size of the immiscible vegetable oil or alkanol. Such in-line or batch reactors allow the production of the vegetable C₁₋₄ alkyl ester continuously, semi-continuously, or in batch-mode.

Under an alternative embodiment, the vegetable C₁₋₄ alkyl ester is produced by an ultrasonic reactor method. In the ultrasonic reactor method, the ultrasonic waves cause the reaction mixture to produce and collapse bubbles constantly. This cavitation simultaneously provides the mixing and heating required to carry out the transesterification process. Using an ultrasonic reactor for vegetable C₁₋₄ alkyl ester production drastically reduces the reaction time, reaction temperatures, and energy input.

Under still another embodiment, the vegetable C₁₋₄ alkyl ester is produced by a lipase-catalyzed method. The use of enzymes as a catalyst for the transesterification may be used to give very good yields from crude and used vegetable oils using lipases. The use of lipases makes the reaction less sensitive to high free fatty acid content.

As used herein, the phrase “vegetable oil” synonymous with the phrase “vegetable fat”. Vegetable oil may be liquid or solid at room temperature or at standard pressure and temperature.

The vegetable oil maybe be derived from any appropriate source. The vegetable oil may be virgin vegetable oil, a recycled vegetable oil, a vegetable oil that is a byproduct of another manufacturing process, or any mixture thereof.

Suitable vegetable oils are mixtures of triglycerides. Such vegetable oils are extracted from seeds or other parts of fruits. Examples of oils extracted from seeds include soybean oil, rapeseed oil, and cocoa butter. Examples of oils extracted from other parts of fruits include olive oil, palm oil, and rice bran oil.

Under one embodiment, the vegetable C₁₋₄ alkyl ester is a vegetable methyl ester, wherein the vegetable methyl ester is avocado methyl ester, canola methyl ester, coconut methyl ester, corn methyl ester, cottonseed methyl ester, flaxseed methyl ester, grape seed methyl ester, hemp seed methyl ester, linseed methyl ester, olive methyl ester, palm methyl ester, peanut methyl ester, safflower methyl ester, soybean methyl ester, sunflower methyl ester. Under one embodiment, the vegetable C₁₋₄ alkyl ester is a vegetable methyl ester, wherein the vegetable methyl ester is a mixture of any of the preceding

Under one embodiment, the vegetable C₁₋₄ alkyl ester is a vegetable methyl ester, wherein the vegetable methyl ester is cottonseed methyl ester, corn methyl ester, flaxseed methyl ester, linseed methyl ester, soybean methyl ester, sunflower methyl ester, or a mixture thereof

As used herein, the phrases “cottonseed methyl ester”, “corn methyl ester”, “flaxseed methyl ester”, “linseed methyl ester”, “soybean methyl ester”, “sunflower methyl ester”, and like mean methyl esters that are derived from their respective oils.

The soybean methyl ester is derived from soybean oil. Soybean oil comprises about 16 wt % saturated fat, about 23 wt % monounsaturated fat, and about 58 wt % of polyunsaturated fat. The major unsaturated fatty acids in soybean oil triglycerides are the polyunsaturates α-linolenic acid (C-18:3) at about 7 to about 10 wt %%, linoleic acid (C-18:2) at about 51 wt %; the monounsaturate oleic acid (C-18:1) at about 23%, stearic acid (C-18:0) at about 4%, and palmitic acid (C-16:0) at about 10%.

The corn methyl ester is derived from corn oil. Under one embodiment, corn oil comprises about 13 wt % saturated fat, about 28 wt % monounsaturated fat, and about 55 wt % of polyunsaturated fat.

The flaxseed methyl ester is derived from flaxseed oil. Under one embodiment, flaxseed oil has about 9 wt % saturated fat, about 18 wt % monounsaturated fat, and about 68 wt % of polyunsaturated fat.

The linseed methyl ester is derived from linseed oil. Under one embodiment, linseed oil has about 9 wt % saturated fat, about 18 wt % monounsaturated fat, and about 68 wt % of polyunsaturated fat.

The cottonseed methyl ester is derived from cottonseed oil. Under one embodiment, cottonseed oil comprises about 26 wt % saturated fat, about 18 wt % monounsaturated fat, and about 52 wt % of polyunsaturated fat.

The sunflower methyl ester is derived from corn oil. Under one embodiment, sunflower oil comprises about 10 wt % saturated fat, about 20 wt % monounsaturated fat, and about 66 wt % of polyunsaturated fat.

Under one embodiment, the vegetable C₁₋₄ alkyl ester is a vegetable methyl ester, wherein the vegetable methyl ester is soybean methyl ester.

As used herein, the term “polysiloxane” may also be known as polymerized siloxane or silicone.

Polysiloxane contains an inorganic silicon-oxygen backbone chain —Si—O—Si—O—Si—O— with organic side groups attached to the silicon atoms, and terminal groups. Polysiloxane comprises the repeating —[RR′SiO]—, wherein R and R′ are organic groups which may be the same or different.

The term “polysiloxane” is to be interpreted broadly. Examples of polysiloxane include both a polysiloxane homopolymer (a polymer comprising a single species of monomer) and a polysiloxane copolymer.

The phrase “polysiloxane copolymer” means a polymer comprising more than one species of monomer. Examples of a polysiloxane copolymer include a statistical copolymer, a random copolymer, an alternating copolymer, a periodic copolymer, and a block copolymer. Under one embodiment of the present invention, the copolymer is a statistical copolymer or a random copolymer. The term “terpolymer” is a polymer comprising three species of monomer.

Polysiloxane may be obtained commercially from any suitable commercial source. Examples of suppliers include Dow Corning Silicones (Midland, Michigan, USA), Evonik Industries AG (Essen, Germany), Momentive Performance Materials Inc. (Waterford, N.Y., USA), SiVance LLC (Gainesville, Fla., USA), Shin-Etsu Silicones (Tokyo, Japan), Wacker Chemie (Munich, Germany), Bluestar Silicones (Lyon, France), JNC Corporation (Ichihara, Japan), Wacker Asahikasei Silicone (Chikusei-shi, Japan), Dow Corning Toray (Tokyo, Japan), Wego Chemical Group (Great Neck, N.Y., USA), Shandong Dayi Chemical Co., Ltd. (Yantai City, Shandong Province, China), Anhui Zinca Silicone Technologies Co., Ltd. (Anhui, China), Livchem Logistics GmbH (Frankfurt am Main, Germany), L. Bowing GmbH (Hofheim am Taunus, Germany), Zhongtian East Fluorine Silicon Material Co., Ltd. (Quzhou City, Zhejiang Province, China), Zhejiang Change Silicone Materials Co., Ltd. (Quzhou, Zhejiang, China), and Tianjin Hero-Land S&T Development Co., Ltd. (Tianjin, China).

Under one embodiment, the polysiloxane is polydimethylsiloxane (PDMS) of formula (CH₃)₃Si—[Si(CH₃)₂—O]ₙ—Si(CH₃)₃, wherein n is a large number.

Under one embodiment, the organic side groups link two or more of the —Si—O— backbones together. Depending on the —Si—O— chain lengths, side groups, and crosslinking, the synthesized polysiloxanes exhibit a wide variety of physical and chemical properties.

Under one embodiment, the polysiloxane is a branched polysiloxane. Examples of branched polysiloxanes include star-branched polysiloxanes, comb-branched polysiloxanes, and dendritic-branched polysiloxanes. The branched polysiloxane may be prepared by the coupling of reactive blocks using grafting techniques.

The identity of the terminal group has an effect on the miscibility of the polysiloxane with the vegetable C₁₋₄ alkyl ester, and thus on the ability to perform well as a water repellant. The preferred polysiloxane is a functionalized polysiloxane. One preferred polysiloxane is comprised at least one terminal group or a terminal ligand, that is polar.

Examples of a functionalized polysiloxane include polysiloxanes that are terminated with one or more ligands such as halide, —Cl, —Br, aminoalkyl, —(CH₂)ₐNH₂, hydroxyl, —OH, vinyl, —CH═CH₂, glycidyl ether, —(CH₂)_{b}—O—(CH₂)_{c}—OH, —(CH₂)_{d}—O(CH₂)ₑ-cyclo(C₂H₃O), epoxycyclohexylethyl, —(CH₂)₂—(C₆H₉O), acrylamidoalkyl, —(CH₂)_{f}13 N—CO—CH═CH₂, and mixtures thereof; wherein a, b, c, d, e, and f are each independently are 0 to 3.

The functionalized polysiloxane may have one, two, or more of such ligands.

Under another embodiment, the polysiloxanes are terminated by a C₁₋₁₈ alkyl group or —(CH₂)ₕ—CH₃, wherein h=0 to 17.

The polysiloxane backbone may be substituted by various groups. The polysiloxane comprises repeating groups —[SiRR′—O]—, wherein R and R′ are each independently selected from the group consisting of hydrogen, —H, C₁₋₁₈ alkyl, —(CH₂)ᵣ—CH₃, methyl, —CH₃, -ethyl, —CH₂—CH₃, hydroxypolyalkoxyalkyl, —(CH₂)ₛ—(O(CH₂)ₜ)ᵤ—OH, phenyl, Ph, —(CH₂)ᵥ—CH(Me)-Ph, and mixtures thereof, wherein r=0 to 17, and s, t, u, and v each independently are 0 to 5.

Examples of C₁₋₁₈ alkyl include methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, isomers thereof, and mixtures thereof.

Hydroxypolyalkoxyalkyl is a polyether, such as polyethylene, polypropylene, or polybutylene, that is terminated with a hydroxyl group.

The present invention is also directed to a composition comprising a vegetable alkyl ester and a binder resin, and optionally a polysiloxane.

The weight ratio of the vegetable C₁₋₄ alkyl ester with the binder resin is dictated by the end use. Under one embodiment, the weight ratio of the vegetable C₁₋₄ alkyl ester with the binder resin is about 5 wt % to about 95 wt % of vegetable C₁₋₄ alkyl ester and about 5 wt % to about 95 wt % of a binder resin. Under one embodiment, the weight ratio of the vegetable C₁₋₄ alkyl ester with the binder resin is about 5 wt % to about 95 wt % of vegetable C₁₋₄ alkyl ester and about 5 wt % to about 95 wt % of a binder resin. Under one embodiment, the weight ratio of the vegetable C₁₋₄ alkyl ester with the binder resin is about 20 wt % to about 95 wt % of vegetable C₁₋₄ alkyl ester and about 5 wt % to about 80 wt % of a binder resin. Under one embodiment, the weight ratio of the vegetable C₁₋₄ alkyl ester with the binder resin is about 50 wt % to about 95 wt % of vegetable C₁₋₄ alkyl ester and about 5 wt % to about 50 wt % of a binder resin. Under one embodiment, the weight ratio of the vegetable C₁₋₄ alkyl ester with the binder resin is about 70 wt % to about 95 wt % of vegetable C₁₋₄ alkyl ester and about 5 wt % to about 30 wt % of a binder resin. Under one embodiment, the weight ratio of the vegetable C₁₋₄ alkyl ester with the binder resin is about 5 wt % to about 70 wt % of vegetable C₁.₄ alkyl ester and about 30 wt % to about 95 wt % of a binder resin. Under one embodiment, the weight ratio of the vegetable C₁₋₄ alkyl ester with the binder resin is about 20 wt % to about 70 wt % of vegetable C₁₋₄ alkyl ester and about 30 wt % to about 80 wt % of a binder resin. Under one embodiment, the weight ratio of the vegetable Cᵢ.₄ alkyl ester with the binder resin is about 50 wt % to about 70 wt % of vegetable C₁₋₄ alkyl ester and about 30 wt % to about 50 wt % of a binder resin. Under one embodiment, the weight ratio of the vegetable C₁₋₄ alkyl ester with the binder resin is about 5 wt % to about 50 wt % of vegetable C₁₋₄ alkyl ester and about 50 wt % to about 95 wt % of a binder resin. Under one embodiment, the weight ratio of the vegetable C₁₋₄ alkyl ester with the binder resin is about 20 wt % to about 50 wt % of vegetable C₁₋₄ alkyl ester and about 50 wt % to about 80 wt % of a binder resin. Under one embodiment, the weight ratio of the vegetable C₁₋₄ alkyl ester with the binder resin is about 5 wt % to about 20 wt % of vegetable C₁₋₄ alkyl ester and about 80 wt % to about 95 wt % of a binder resin.

The binder resin can include one or more polymeric materials, homopolymeric materials, copolymeric materials, oligomeric materials, resin materials, combinations thereof, or any mixture thereof. Illustrative binder resins can include, but are not limited to, a melamine-formaldehyde resin, a urea-formaldehyde resin, a phenol-formaldehyde resin, a melamine-urea-formaldehyde resin, a phenol-melamine-urea-formaldehyde resin, a resorcinol-formaldehyde resin, a phenol-resorcinol-formaldehyde resin, a methylene diphenyl diisocyanate (MDI), a polymeric methylene diphenyl diisocyanate (pMDI), a polyurethane (PU), a polyamide-epihalohydrin (PAE) resin, a styrene maleic anhydride (SMA) copolymer, a cationic styrene maleimide (SMI) resin, emulsified polymer isocyanate (EPI) adhesives, combinations thereof, or any mixture thereof. In some examples, the emulsified polymer isocyanate adhesives can include two-component adhesives based on a reaction mixture of water based emulsions, such as styrene butadiene rubber (SBR), ethylene vinyl acetate (EVA), or polyvinyl acetates (PVAc) with an isocyanate hardener or cross-linker for forming water-resistant bonds. The vinyl acetate copolymer emulsions can be internally flexibilized with a linker, for example, ethylene or acrylate, to form vinyl acetate ethylene (VAE) copolymers, ethylene vinyl acetate (EVA) copolymers, or vinyl acetate acrylate (VAA) copolymers.

Under one embodiment, the binder resin is typically chosen from an isocyanate component, a formaldehyde resin, a protein-based adhesive, or a combination thereof. The isocyanate component is typically a polymeric diphenylmethane diisocyanate (pMDI); however, other isocyanates can also be utilized as described below. The formaldehyde resin is typically a urea formaldehyde (UF) resin or a melamine UF resin, however, other formaldehydes can also be used, such as a phenol formaldehyde (PF) resin. The protein-based adhesive is typically a soy-based adhesive, however, other protein-based adhesives can also be utilized, such as a casein-based adhesive.

In general, the binder resin is only present for some amount of time prior to a reaction product thereof curing to a final cured state to form the adhesive system such as the engineered wood composite. The reaction product is generally the final cured state of the adhesive system after reaction occurs between the components used to form the article, such as after reaction between the isocyanate component and an isocyanate-reactive component.

The binder component generally adheres to the lignocellulosic particles to one another, once cured. For example, the reaction product of the isocyanate component and the isocyanate-reactive component can bond the lignocellulosic particles via linkages, e.g., urea linkages. General mechanisms of adhesion, for wood composites, are detailed on pages 397 through 399 of The Polyurethanes Handbook (David Randall & Steve Lee eds., John Wiley & Sons, Ltd. 2002).

The isocyanate component is typically a polyisocyanate having two or more isocyanate functional groups. The isocyanate function group has the formula —NCO. Suitable organic polyisocyanates include aliphatic isocyanates, cycloaliphatic isocyanates, arylaliphatic isocyanates, and aromatic isocyanates. In certain embodiments, the isocyanate component is chosen from diphenylmethane diisocyanates (MDIs), polymeric diphenylmethane diisocyanates (pMDIs), and combinations thereof. Polymeric diphenylmethane diisocyanates can also be called polymethylene polyphenylene polyisocyanates. In other embodiments, the isocyanate component is an emulsifiable MDI (eMDI). Examples of other suitable isocyanates include toluene diisocyanates (TDIs), hexamethylene diisocyanates (HDIs), isophorone diisocyanates (IPDIs), naphthalene diisocyanates (NDIs), and combinations thereof. Under one embodiment, the isocyanate component is MDI. Under one embodiment, the isocyanate component is pMDI. Under one embodiment, the isocyanate component is a combination of MDI and pMDI.

In certain embodiments, the isocyanate component is an isocyanate-terminated prepolymer. The isocyanate-terminated prepolymer is a reaction product of an isocyanate and a polyol and/or a polyamine. The isocyanate may be any type of isocyanate in the polyurethane art, such as one of the polyisocyanates. For the isocyanate-terminated prepolymer, the polyol is typically chosen from ethylene glycol, diethylene glycol, propylene glycol, dipropylene glycol, butane diol, glycerol, trimethylolpropane, triethanolamine, pentaerythritol, sorbitol, and combinations thereof. The polyol may also be a polyol as described and exemplified further below with discussion of the isocyanate-reactive component. The polyamine is typically chosen from ethylene diamine, toluene diamine, diaminodiphenylmethane and polymethylene polyphenylene polyamines, aminoalcohols, and combinations thereof. Examples of suitable aminoalcohols include ethanolamine, diethanolamine, triethanolamine, and combinations thereof. The isocyanate-terminated prepolymer may be formed from a combination of two or more of the aforementioned polyols and/or polyamines.

The isocyanates or isocyanate-terminated prepolymers may also be used in the form of an aqueous emulsion by mixing such materials with water in the presence of an emulsifying agent. The isocyanate component may also be a modified isocyanate, such as, carbodiimides, allophanates, isocyanurates, and biurets.

Other suitable isocyanates include those described in U.S. Pat. No. 4,742,113 to Gismondi et al.; U.S. Pat. No. 5,093,412 to Mente et al.; U.S. Pat. No. 5,425,976 to Clarke et al.; U.S. Pat. No. 6,297,313 to Hsu; U.S. Pat. No. 6,352,661 to Thompson et al.; U.S. Pat. No. 6,451,101 to Mente et al.; U.S. Pat. No. 6,458,238 to Mente et al.; U.S. Pat. No. 6,464,820 to Mente et al.; U.S. Pat. No. 6,638,459 to Mente et al.; U.S. Pat. No. 6,649,098 to Mente et al.; U.S. Pat. No. 6,822,042 to Capps; U.S. Pat. No. 6,846,849 to Capps; U.S. Pat. No. 7,422,787 to Evers et al.; U.S. Pat. No. 7,439,280 to Lu et al.; and U.S. Pat. No. 8,486,523 to Mente; and U.S. Publication No. 2005/0242459 to Savino et al.; the disclosures of which are incorporated herein by reference in their entirety in various non-limiting embodiments.

Specific examples of suitable isocyanate components are commercially available from BASF Corporation of Florham Park, N.J., under the trademark LUPRANATE®, such as Lupranate M, Lupranate M20, Lupranate MI, Lupranate M20SB, Lupranate M20HB, and Lupranate M20FB isocyanates. In one embodiment, the isocyanate component is Lupranate M20. In another embodiment, the isocyanate component is Lupranate M20FB. It is to be appreciated that the isocyanate component may include any combination of the aforementioned isocyanates and/or isocyanate-terminated prepolymers.

The wax substitute of the present invention has many uses, including substituting for petroleum-based waxes and oils. The wax substitute of the present invention may be used as a substitute for mineral oils, other oils. Under various embodiments, such a wax substitute may be used as a medicine, laxative, cell culture growth medium, veterinary composition, cosmetic ingredient, non-conductive coolant liquid, transformer oil, lubricant, cutting fluid, spindle oil, water-proofing composition, heat transfer oil, hydraulic fluid, food ingredient, butcher block preparation, and like.

Under one embodiment, the mixture of vegetable C₁₋₄ alkyl ester and polysiloxane may be used as a wax substitute in preparation of engineer wood composites.

Under one embodiment, the mixture of the vegetable C₁₋₄ alkyl ester and polysiloxane substitutes for the wax completely. Under another embodiment, the mixture of the vegetable C₁₋₄ alkyl ester and polysiloxane substitutes for the wax partially.

The mixture of the vegetable C₁₋₄ alkyl ester and polysiloxane may be used as a partial substitution for wax. The wax composition may comprise a variety of waxes including fossil waxes (e.g., montan, ozocerite, pyropissite, and the like); non-fossil waxes such as animal or vegetable waxes (e.g., beeswax, plant waxes such as carnauba or candelilla, and the like); partially synthetic waxes (e.g., alcohol waxes, wool wax, and the like); synthetic waxes (e.g., amide waxes, polyethylene waxes, Fischer-Tropsch, polyolefins, Ziegler process wax, and the like); petroleum waxes such as macro-crystalline waxes or microcrystalline waxes (e.g., paraffins, slack wax, slack wax raffinates, decoiled slack wax, soft wax, semi-refined wax, filtered wax, fully refined wax, bright stock wax, plastic microwaxes, hard microwaxes, and the like); and combinations thereof. Preferred waxes for use herein include, petroleum waxes, synthetic waxes, and combinations thereof.

The present invention is also directed to the use of the mixture of the vegetable C₁₋₄ alkyl ester and polysiloxane as the treatment of lignocellulose particles prior to the mixing of the lignocellulose particles with the binder resin.

Under one embodiment, the method for producing the lignocellulose composite product includes contacting or combining the plurality of lignocellulose particles with the composition of the vegetable C₁₋₄ alkyl ester and polysiloxane and the binder resin to produce a mixture. The binder resin in the mixture can be at least partially cured to produce the lignocellulose composite product.

The amount of the vegetable C₁₋₄ alkyl ester and polysiloxane mixture in the lignocellulose composite product can widely vary. Under one embodiment, the lignocellulose composite product comprises about 0.01 wt % to about 0.03 wt % of the vegetable C₁₋₄ alkyl ester and polysiloxane mixture. Under one embodiment, the lignocellulose composite product comprises about 0.01 wt % to about 0.1 wt % of the vegetable C₁₋₄ alkyl ester and polysiloxane mixture. Under one embodiment, the lignocellulose composite product comprises about 0.01 wt % to about 0.3 wt % of the vegetable C₁₋₄ alkyl ester and polysiloxane mixture. Under one embodiment, the lignocellulose composite product comprises about 0.01 wt % to about 1 wt % of the vegetable C₁₋₄ alkyl ester and polysiloxane mixture. Under one embodiment, the lignocellulose composite product comprises about 0.01 wt % to about 3 wt % of the vegetable C₁₋₄ alkyl ester and polysiloxane mixture. Under one embodiment, the lignocellulose composite product comprises about 0.01 wt % to about 10 wt % of the vegetable C₁₋₄ alkyl ester and polysiloxane mixture. Under one embodiment, the lignocellulose composite product comprises about 0.03 wt % to about 0.1 wt % of the vegetable C₁₋₄ alkyl ester and polysiloxane mixture. Under one embodiment, the lignocellulose composite product comprises about 0.03 wt % to about 0.3 wt % of the vegetable C₁₋₄ alkyl ester and polysiloxane mixture. Under one embodiment, the lignocellulose composite product comprises about 0.03 wt % to about 1 wt % of the vegetable C₁₋₄ alkyl ester and polysiloxane mixture. Under one embodiment, the lignocellulose composite product comprises about 0.03 wt % to about 3 wt % of the vegetable C₁₋₄ alkyl ester and polysiloxane mixture. Under one embodiment, the lignocellulose composite product comprises about 0.03 wt % to about 10 wt % of the vegetable C₁₋₄ alkyl ester and polysiloxane mixture. Under one embodiment, the lignocellulose composite product comprises about 0.1 wt % to about 0.3 wt % of the vegetable C₁₋₄ alkyl ester and polysiloxane mixture. Under one embodiment, the lignocellulose composite product comprises about 0.1 wt % to about 1 wt % of the vegetable C₁₋₄ alkyl ester and polysiloxane mixture. Under one embodiment, the lignocellulose composite product comprises about 0.1 wt % to about 3 wt % of the vegetable C₁₋₄ alkyl ester and polysiloxane mixture. Under one embodiment, the lignocellulose composite product comprises about 0.1 wt % to about 10 wt % of the vegetable C₁₋₄ alkyl ester and polysiloxane mixture. Under one embodiment, the lignocellulose composite product comprises about 0.3 wt % to about 1 wt % of the vegetable C₁₋₄ alkyl ester and polysiloxane mixture. Under one embodiment, the lignocellulose composite product comprises about 0.3 wt % to about 3 wt % of the vegetable C₁₋₄ alkyl ester and polysiloxane mixture. Under one embodiment, the lignocellulose composite product comprises about 0.3 wt % to about 10 wt % of the vegetable C₁₋₄ alkyl ester and polysiloxane mixture. Under one embodiment, the lignocellulose composite product comprises about 1 wt % to about 3 wt % of the vegetable C₁₋₄ alkyl ester and polysiloxane mixture. Under one embodiment, the lignocellulose composite product comprises about 1 wt % to about 10 wt % of the vegetable C₁₋₄ alkyl ester and polysiloxane mixture. Under one embodiment, the lignocellulose composite product comprises about 3 wt % to about 10 wt % of the vegetable C₁₋₄ alkyl ester and polysiloxane mixture. In all of the above embodiments, the wt % are based on a dried weight of the lignocellulose particles.

A variety of lignocellulose composite products and other fiber or wood based composite products can be made by bonding the plurality of lignocellulose particles or other fibers and/or particles, and the mixture of vegetable C₁₋₄ alkyl ester and polysiloxane. The fiber or wood-based composite products may include or be made from lignocellulose particles, cellulosic fibers, synthetic fibers.

The lignocellulose particles include fiber webs (e.g., cellulosic fiber webs) and/or the fibers (e.g., cellulosic fibers), which include at least one material selected from bleached furnish, softwood, hardwood, wood pulp, mechanical pulp, or any mixture thereof. The terms “cellulosic”, “fiber”, “mat”, and the like, is meant to include any product incorporating wood or fiber having cellulose as a major constituent. The terms “fibers” or “wood” include virgin pulps, recycled cellulosic fibers, or fiber mixtures containing virgin cellulosic fibers and/or reconstituted cellulosic fibers. Fibers suitable for making or producing the cellulosic fiber webs, fibrous sheets, and wood products and sheets of embodiments described herein can include: non-wood fibers, such as cotton fibers or cotton derivatives, abaca, kenaf, sabai grass, flax, esparto grass, straw, jute hemp, bagasse, milkweed floss fibers, and pineapple leaf fibers.

Under one embodiment, the present invention provides derivatives of native lignin recovered during or after pulping of lignocellulosic feedstocks. The pulp may be from any suitable lignocellulosic feedstock including hardwoods, softwoods, annual fibers, and combinations thereof.

Hardwood feedstocks include Acacia; Afzelia; Synsepalum duloificum; Albizia; Alder (e.g., Alnus glutinosa, Alnus rubra); Applewood; Arbutus; Ash (e.g., F. nigra, F. quadrangulata, F. excelsior, F. pennsylvanica lanceolata, F. latifolia, F. profunda, F. americana); Aspen (e.g., P. grandidentata, P. tremula, P. tremuloides); Australian Red Cedar (Toona ciliata); Ayna (Distemonanthus benthamianus); Balsa (Ochroma pyramidale); Basswood (e.g., T. americana, T. heterophylla); Beech (e.g., F. glvatica, F. grandifolia); Birch; (e.g., Betula populifolia, B. nigra, B. papyrifera, B. lenta, B. alleghaniensis/B. lutea, B. pendula, B. pubescens); Blackbean; Blackwood; Bocote; Boxelder; Boxwood; Brazilwood; Bubinga; Buckeye (e.g., Aesculus hippocastanum, Aesculus glabra, Aesculus flava/Aesculus octandra); Butternut; Catalpa; Cherry (e.g., Prunus serotina, Prunus pennylvanica, Prunus avium); Crabwood; Chestnut; Coachwood; Cocobolo; Corkwood; Cottonwood (e.g., Populus balsamifera, Populus deltoides, Populus sargentii, Populus heterophylla); Cucumbertree; Dogwood (e.g., Cornus florida, Cornus nuttallii); Ebony (e.g., Diospyros kurzii, Diospyros melanida, Diospyros crassiflora); Elm (e.g., Ulmus americana, Ulmus procera, Ulmus thomasii, Ulmus rubra, Ulmus glabra); Eucalyptus; Greenheart; Grenadilla; Gum (e.g., Nyssa sylvatica, Eucalyptus globulus, Liquidambar styraciflua, Nyssa aquatica); Hickory (e.g., Carya alba, Carya glabra, Carya ovata, Carya laciniosa); Hornbeam; Hophornbeam; Ip; Iroko; Ironwood (e.g., Bangkirai, Carpinus caroliniana, Casuarina equisetifolia, Choricbangarpia subargentea, Copaifera spp., Eusideroxylon zwageri, Guajacum officinale, Guajacum sanctum, Hopea odorata, Ipe, Krugiodendron ferreum, Lyonothamnus lyonii (L. floribundus), Mesua ferrea, Olea spp., Olneya tesota, Ostrya virginiana, Parrotia persica, Tabebuia serratifolia); Jacaranda; Jotoba; Lacewood; Laurel; Limba; Lignum vitae; Locust (e.g., Robinia pseudacacia, Gleditsia triacanthos); Mahogany; Maple (e.g., Acer saccharum, Acer nigrum, Acer negundo, Acer rubrum, Acer saccharinum, Acer pseudoplatanus); Meranti; Mpingo; Oak (e.g., Quercus macrocarpa, Quercus alba, Quercus stellata, Quercus bicolor, Quercus virginiana, Quercus michauxii, Quercus prinus, Quercus muhlenbergii, Quercus chysolepis, Quercus lyrata, Quercus robur, Quercus petraea, Quercus rubra, Quercus velutina, Quercus laurifolia, Quercus falcata, Quercus nigra, Quercus phellos, Quercus texana); Obeche; Okoume; Oregon Myrtle; California Bay Laurel; Pear; Poplar (e.g., P. balsamifera, P. nigra, Hybrid Poplar (Populus.times.canadensis)); Ramin; Red cedar; Rosewood; Sal; Sandalwood; Sassafras; Satinwood; Silky Oak; Silver Wattle; Snakewood; Sourwood; Spanish cedar; American sycamore; Teak; Walnut (e.g., Juglans nigra, Juglans regia); Willow (e.g., Salix nigra, Salix alba); Yellow poplar (Liriodendron tulipifera); Bamboo; Palmwood; and combinations/hybrids thereof.

For example, hardwood feedstocks for the present invention may be selected from Acacia, Aspen, Beech, Eucalyptus, Maple, Birch, Gum, Oak, Poplar, and combinations/hybrids thereof. The hardwood feedstocks for the present invention may be selected from Populus spp. (e.g., Populus tremuloides), Eucalyptus spp. (e.g., Eucalyptus globulus), Acacia spp. (e.g., Acacia dealbata), and combinations/hybrids thereof.

Softwood feedstocks include Araucania (e.g., A. cunninghamii, A. angustifolia, A. araucana); softwood Cedar (e.g., Juniperus virginiana, Thuja plicata, Thuja occidentalis, Chamaecyparis thyoides Callitropsis nootkatensis); Cypress (e.g., Chamaecyparis, Cupressus Taxodium, Cupressus arionica, Taxodium distichum, Chamaecyparis obtusa, Chamaegparis lawsoniana, Cupressus semperviren); Rocky Mountain Douglas fir; European Yew; Fir (e.g., Abies balsamea, Abies alba, Abies procera, Abies amabilis); Hemlock (e.g., Tsuga canadensis, Tsuga mertensiana, Tsuga heterophylla); Kauri; Kaya; Larch (e.g., Larix decidua, Larix kaempferi, Larix laricina, Larix occidentalis); Pine (e.g., Pinus nigra, Pinus banksiana, Pinus contorta, Pinus radiata, Pinus ponderosa, Pinus resinosa, Pinus sylvestris, Pinus strobus, Pinus monticola, Pinus lambertiana, Pinus taeda, Pinus palustris, Pinus rigida, Pinus echinata); Redwood; Rimu; Spruce (e.g., Picea abies, Picea mariana, Picea rubens, Picea sitchensis, Picea glauca); Sugi; and combinations/hybrids thereof.

For example, softwood feedstocks which may be used herein include cedar; fir; pine; spruce; and combinations thereof. The softwood feedstocks for the present invention may be selected from loblolly pine (Pinus taeda), radiata pine, jack pine, spruce (e.g., white, interior, black), Douglas fir, Pinus silvestris, Picea abies, and combinations/hybrids thereof. The softwood feedstocks for the present invention may be selected from pine (e.g., Pinus radiata, Pinus taeda); spruce; and combinations/hybrids thereof.

Annual fiber feedstocks include biomass derived from annual plants, plants that complete their growth in one growing season and therefore must be planted yearly. Examples of annual fibers include flax, cereal straw (wheat, barley, oats), sugarcane bagasse, rice straw, corn stover, corn cobs, hemp, fruit pulp, alfa grass, switchgrass, and combinations/hybrids thereof. Industrial residues like corn cobs, fruit peals, seeds, etc. may also be considered annual fibers since they are commonly derived from annual fiber biomass such as edible crops and fruits. For example, the annual fiber feedstock may be selected from wheat straw, corn stover, corn cobs, sugar cane bagasse, and combinations/hybrids thereof.

The derivatives of native lignin will vary with the type of process used to separate native lignins from cellulose and other biomass constituents. Preparations very similar to native lignin can be obtained by (1) solvent extraction of finely ground wood (milled-wood lignin, MWL) or by (2) acidic dioxane extraction (acidolysis) of wood. Derivatives of native lignin can be also isolated from biomass pre-treated using (3) steam explosion, (4) dilute acid hydrolysis, (5) ammonia fiber expansion, (6) autohydrolysis methods. Derivatives of native lignin can be recovered after pulping of lignocellulosic including industrially operated kraft, soda pulping (and their modifications) or sulfite pulping. In addition, a number of various pulping methods have been developed but not industrially introduced. Among them four major “organosolv” pulping methods tend to produce highly-purified lignin mixtures. The first organosolv method uses ethanol/solvent pulping (aka the Alcell.R™. process); the second organosolv method uses alkaline sulfite anthraquinone methanol pulping (aka the “ASAM” process); the third organosolv process uses methanol pulping followed by methanol, NaOH, and anthraquinone pulping (aka the “Organocell” process); the fourth organosolv process uses acetic acid/hydrochloric acid or formic acid pulping (aka the “Acetosolv” process).

Further, fibers or wood used in connection with selected embodiments described herein include naturally occurring pulp-derived fibers or reconstituted cellulosic fibers such as lyocell or rayon. Fibers or wood can be liberated from their source material by any one of a number of chemical pulping processes familiar to one experienced in the art including sulfate, sulfite, polysulfide, soda pulping, as well as other processes. The pulp can be bleached if desired by chemical means including the use of chlorine, chlorine dioxide, oxygen, ozone, hydrogen peroxide, alkaline peroxide, rear earth peroxides, as well as other compounds. Naturally occurring pulp-derived fibers are referred to herein simply as “pulp-derived” fibers or wood. The fiber or paper products discussed and described herein can include a blend of conventional fibers (whether derived from virgin pulp or recycle sources) and high coarseness lignin-rich tubular fibers, such as bleached chemical thermomechanical pulp (BCTMP). Pulp-derived fibers thus can also include high yield fibers such as BCTMP as well as thermomechanical pulp (TMP), chemithermomechanical pulp (CTMP) and alkaline peroxide mechanical pulp (APMP). Recycled fibers are generally shorter, stiffer, curlier and more brittle than virgin fibers. Dewatering tests can assess fines content and the degree of external fibrillation. These tests measure how easily water drains from the wood fibers, furnish, or pulp. The Schopper-Riegler (SR) number and the Canadian Standard Freeness (CSF) are the most common dewatering tests. The SR number increases with beating and fines content while the CSF decreases.

The starting material, from which the particles can be derived from, can be reduced to the appropriate size, for a particular product being produced, by various processes such as hogging, grinding, hammer milling, tearing, shredding, and/or flaking. Examples of suitable forms of the lignocellulose particles include chips, fibers, shavings, sawdust, dust, and like.

The lignocellulose particles can be contacted with the mixture of vegetable C₁₋₄ alkyl ester and polysiloxane without any binder resin. This can be achieved by spraying, coating, agitating, mixing, stirring, blending, tumbling, brushing, falling film or curtain coater, dipping, soaking, extrusion, or the like. The plurality of lignocellulose particles can be contacted with the mixture of vegetable C₁₋₄ alkyl ester and polysiloxane to create silicone-treated lignocellulose particles.

Depending on the use of the silicone-treated lignocellulose particles, the loading level of the mixture of vegetable C₁₋₄ alkyl ester and polysiloxane may vary significantly. Under one embodiment, the silicone-treated lignocellulose particles are subsequently contacted with binder resin. Under such embodiment, the combination of lignocellulose particles and the mixture of vegetable C₁₋₄ alkyl ester and polysiloxane i.e., silicone-treated lignocellulose particles, may comprise about 0.01 wt % to 10 wt % of the mixture of vegetable C₁₋₄ alkyl ester and polysiloxane. Under one embodiment, the silicone-treated lignocellulose particles comprise about 0.01 wt % to 10 wt % of the mixture of vegetable C₁₋₄ alkyl ester and polysiloxane. Under one embodiment, the silicone-treated lignocellulose particles comprise about 0.01 wt % to 3 wt % of the mixture of vegetable C₁₋₄ alkyl ester and polysiloxane. Under one embodiment, the silicone-treated lignocellulose particles comprise about 0.01 wt % to 1 wt % of the mixture of vegetable C₁₋₄ alkyl ester and polysiloxane. Under one embodiment, the silicone-treated lignocellulose particles comprise about 0.01 wt % to 0.3 wt % of the mixture of vegetable C₁₋₄ alkyl ester and polysiloxane. Under one embodiment, the silicone-treated lignocellulose particles comprise about 0.01 wt % to 0.1 wt % of the mixture of vegetable C₁₋₄ alkyl ester and polysiloxane. Under one embodiment, the silicone-treated lignocellulose particles comprise about 0.01 wt % to 0.03 wt % of the mixture of vegetable C₁₋₄ alkyl ester and polysiloxane. Under one embodiment, the silicone-treated lignocellulose particles comprise about 0.03 wt % to 10 wt % of the mixture of vegetable C₁₋₄ alkyl ester and polysiloxane. Under one embodiment, the silicone-treated lignocellulose particles comprise about 0.03 wt % to 3 wt % of the mixture of vegetable C₁₋₄ alkyl ester and polysiloxane. Under one embodiment, the silicone-treated lignocellulose particles comprise about 0.03 wt % to 1 wt % of the mixture of vegetable C₁₋₄ alkyl ester and polysiloxane. Under one embodiment, the silicone-treated lignocellulose particles comprise about 0.03 wt % to 0.3 wt % of the mixture of vegetable C₁₋₄ alkyl ester and polysiloxane. Under one embodiment, the silicone-treated lignocellulose particles comprise about 0.03 wt % to 0.1 wt % of the mixture of vegetable C₁₋₄ alkyl ester and polysiloxane. Under one embodiment, the silicone-treated lignocellulose particles comprise about 0.1 wt % to 10 wt % of the mixture of vegetable C₁₋₄ alkyl ester and polysiloxane. Under one embodiment, the silicone-treated lignocellulose particles comprise about 0.1 wt % to 3 wt % of the mixture of vegetable C₁₋₄ alkyl ester and polysiloxane. Under one embodiment, the silicone-treated lignocellulose particles comprise about 0.1 wt % to 1 wt % of the mixture of vegetable C₁₋₄ alkyl ester and polysiloxane. Under one embodiment, the silicone-treated lignocellulose particles comprise about 0.1 wt % to 0.3 wt % of the mixture of vegetable C₁₋₄ alkyl ester and polysiloxane. Under one embodiment, the silicone-treated lignocellulose particles comprise about 0.3 wt % to 10 wt % of the mixture of vegetable C₁₋₄ alkyl ester and polysiloxane. Under one embodiment, the silicone-treated lignocellulose particles comprise about 0.3 wt % to 3 wt % of the mixture of vegetable C₁₋₄ alkyl ester and polysiloxane. Under one embodiment, the silicone-treated lignocellulose particles comprise about 0.3 wt % to 1 wt % of the mixture of vegetable C₁₋₄ alkyl ester and polysiloxane. Under one embodiment, the silicone-treated lignocellulose particles comprise about 1 wt % to 10 wt % of the mixture of vegetable C₁₋₄ alkyl ester and polysiloxane. Under one embpdment, the silicone-treated lignocellulose particles comprise about 1 wt % to 3 wt % of the mixture of vegetable C₁₋₄ alkyl ester and polysiloxane. Under one embodiment, the silicone-treated lignocellulose particles comprise about 3 wt % to 10 wt % of the mixture of vegetable C₁₋₄ alkyl ester and polysiloxane.

After the mixture of vegetable C₁₋₄ alkyl ester and polysiloxane and the lignocellulose particles are well blended to create the silicone-treated lignocellulose particles, such particles may be then treated with a binder resin.

Under one embodiment, the silicone-treated lignocellulose particles are treated with an appropriate binder resin. This can be achieved by spraying, coating, agitating, mixing, stirring, blending, tumbling, brushing, falling film or curtain coater, dipping, soaking, extrusion, or the like.

Under another embodiment, the silicone-treated lignocellulose particles are collected and isolated. These silicone-treated lignocellulose particles can then used by adding them to other lignocellulose particles to form another blend, which can then be treated with an appropriate binder resin. This can be achieved by spraying, coating, agitating, mixing, stirring, blending, tumbling, brushing, falling film or curtain coater, dipping, soaking, extrusion, or the like.

Under this embodiment, such silicone-treated lignocellulose particles may have a very loading level of a mixture of vegetable C₁₋₄ alkyl ester and polysiloxane. Such loading levels may be as high as 60 wt % of the mixture of vegetable C₁₋₄ alkyl ester and polysiloxane. Under one embodiment, the silicone-treated lignocellulose particles comprise about 5 wt % to 60 wt % of the mixture of vegetable C₁₋₄ alkyl ester and polysiloxane. Under one embodiment, the silicone-treated lignocellulose particles comprise about 5 wt % to 40 wt % of the mixture of vegetable C₁₋₄ alkyl ester and polysiloxane. Under one embodiment, the silicone-treated lignocellulose particles comprise about 5 wt % to 20 wt % of the mixture of vegetable C₁₋₄ alkyl ester and polysiloxane. Under one embodiment, the silicone-treated lignocellulose particles comprise about 5 wt % to 10 wt % of the mixture of vegetable C₁₋₄ alkyl ester and polysiloxane. Under one embodiment, the silicone-treated lignocellulose particles comprise about 10 wt % to 60 wt % of the mixture of vegetable C₁₋₄ alkyl ester and polysiloxane. Under one embodiment, the silicone-treated lignocellulose particles comprise about 10 wt % to 40 wt % of the mixture of vegetable C₁₋₄ alkyl ester and polysiloxane. Under one embodiment, the silicone-treated lignocellulose particles comprise about 10 wt % to 20 wt % of the mixture of vegetable C₁₋₄ alkyl ester and polysiloxane. Under one embodiment, the silicone-treated lignocellulose particles comprise about 20 wt % to 60 wt % of the mixture of vegetable C₁₋₄ alkyl ester and polysiloxane. Under one embodiment, the silicone-treated lignocellulose particles comprise about 20 wt % to 40 wt % of the mixture of vegetable C₁₋₄ alkyl ester and polysiloxane. Under one embodiment, the silicone-treated lignocellulose particles comprise about 40 wt % to 60 wt % of the mixture of vegetable C₁₋₄ alkyl ester and polysiloxane.

The silicone-treated lignocellulose particles can then used by adding them to other lignocellulose particles to form another blend. The ratio of the silicone-treated lignocellulose particles to the other lignocellulose particles may be anywhere between 5:95 to 95:5. Under one embodiment, the ratio of the silicone-treated lignocellulose particles to the other lignocellulose particles is between about 5:95 to about 95:5 by wt %. Under one embodiment, the ratio of the silicone-treated lignocellulose particles to the other lignocellulose particles is between about 10:90 to about 95:5 by wt %. Under one embodiment, the ratio of the silicone-treated lignocellulose particles to the other lignocellulose particles is between about 20:80 to about 95:5 by wt %. Under one embodiment, the ratio of the silicone-treated lignocellulose particles to the other lignocellulose particles is between about 50:50 to about 95:5 by wt %. Under one embodiment, the ratio of the silicone-treated lignocellulose particles to the other lignocellulose particles is between about 80:20 to about 95:5 by wt %. Under one embodiment, the ratio of the silicone-treated lignocellulose particles to the other lignocellulose particles is between about 90:10 to about 95:5 by wt %. Under one embodiment, the ratio of the silicone-treated lignocellulose particles to the other lignocellulose particles is between about 5:95 to about 90:10 by wt %. Under one embodiment, the ratio of the silicone-treated lignocellulose particles to the other lignocellulose particles is between about 10:90 to about 90:10 by wt %. Under one embodiment, the ratio of the silicone-treated lignocellulose particles to the other lignocellulose particles is between about 20:80 to about 90:10 by wt %. Under one embodiment, the ratio of the silicone-treated lignocellulose particles to the other lignocellulose particles is between about 50:50 to about 90:10 by wt %. Under one embodiment, the ratio of the silicone-treated lignocellulose particles to the other lignocellulose particles is between about 80:20 to about 90:10 by wt %. Under one embodiment, the ratio of the silicone-treated lignocellulose particles to the other lignocellulose particles is between about 5:95 to about 80:20 by wt %. Under one embodiment, the ratio of the silicone-treated lignocellulose particles to the other lignocellulose particles is between about 10:90 to about 80:20 by wt %. Under one embodiment, the ratio of the silicone-treated lignocellulose particles to the other lignocellulose particles is between about 20:80 to about 80:20 by wt %. Under one embodiment, the ratio of the silicone-treated lignocellulose particles to the other lignocellulose particles is between about 50:50 to about 80:20 by wt %. Under one embodiment, the ratio of the silicone-treated lignocellulose particles to the other lignocellulose particles is between about 5:95 to about 50:50 by wt %. Under one embodiment, the ratio of the silicone-treated lignocellulose particles to the other lignocellulose particles is between about 10:90 to about 50:50 by wt %. Under one embodiment, the ratio of the silicone-treated lignocellulose particles to the other lignocellulose particles is between about 20:80 to about 50:50 by wt %. Under one embodiment, the ratio of the silicone-treated lignocellulose particles to the other lignocellulose particles is between about 5:95 to about 20:80 by wt %. Under one embodiment, the ratio of the silicone-treated lignocellulose particles to the other lignocellulose particles is between about 10:90 to about 20:80 by wt %. Under one embodiment, the ratio of the silicone-treated lignocellulose particles to the other lignocellulose particles is between about 5:95 to about 10:90 by wt %.

Under one embodiment, the method for producing the lignocellulose composite product includes contacting or combining the plurality of lignocellulose particles with the composition of the vegetable C₁₋₄ alkyl ester and polysiloxane and the binder resin to produce a mixture. The binder resin in the mixture can be at least partially cured to produce the lignocellulose composite product.

The lignocellulose particles contacted with a mixture of vegetable C₁₋₄ alkyl ester and polysiloxane and a binder resin can be formed into the desired shape before, during, and/or after at least partial curing of the binder resins. Depending on the particular product, the lignocellulose particles contacted with a mixture of vegetable C₁₋₄ alkyl ester and polysiloxane and binder resin can be pressed before, during, or after mixture of vegetable C₁₋₄ alkyl ester and polysiloxane and the binder resin is at least partially cured. For example, the lignocellulose particles contacted with mixture of vegetable C₁₋₄ alkyl ester and polysiloxane and the binder resin can be consolidated or otherwise formed into a desired shape, pressed to a particular density and thickness, and heated to at least partially cure binder resin.

The lignocellulose particles can be contacted with vegetable C₁₋₄ alkyl ester and polysiloxane mixture and binder resin by spraying, coating, agitating, mixing, stirring, blending, tumbling, brushing, falling film or curtain coater, dipping, soaking, extrusion, or the like. The lignocellulose particles contacted with the vegetable C₁₋₄ alkyl ester and polysiloxane mixture and binder resin can be formed into a desired shape before, during, and/or after at least partial curing of vegetable C₁₋₄ alkyl ester and polysiloxane mixture and a binder resin. Depending on the particular product, the lignocellulose particles contacted with vegetable C₁₋₄ alkyl ester and polysiloxane mixture and binder resin can be pressed before, during, and/or after vegetable C₁₋₄ alkyl ester and polysiloxane mixture and the binder resin is at least partially cured. For example, the lignocellulose particles contacted with vegetable C₁₋₄ alkyl ester and polysiloxane mixture and binder resin can be consolidated or otherwise formed into a desired shape, if desired pressed to a particular density and thickness, and heated to at least partially cure vegetable C₁₋₄ alkyl ester and polysiloxane mixture and binder resin.

In some embodiments, the moisture content of the lignocellulose particles, or other fibrous or wood particles or flakes, can be measured and recorded as a first moisture content. In some embodiments, the first moisture content can be about 0.5 wt % to about 15 wt %. Under one embodiment, the first moisture content is about 0.5 wt % to about 15 wt %. Under one embodiment, the first moisture content is about 1 wt % to about 15 wt %. Under one embodiment, the first moisture content is about 3 wt % to about 15 wt %. Under one embodiment, the first moisture content is about 6 wt % to about 15 wt %. Under one embodiment, the first moisture content is about 10 wt % to about 15 wt %. Under one embodiment, the first moisture content is about 0.5 wt % to about 10 wt %. Under one embodiment, the first moisture content is about 1 wt % to about 10 wt %. Under one embodiment, the first moisture content is about 3 wt % to about 10 wt %. Under one embodiment, the first moisture content is about 6 wt % to about 10 wt %. Under one embodiment, the first moisture content is about 0.5 wt % to about 6 wt %. Under one embodiment, the first moisture content is about 1 wt % to about 6 wt %. Under one embodiment, the first moisture content is about 3 wt % to about 6 wt %. Under one embodiment, the first moisture content is about 0.5 wt % to about 3 wt %. Under one embodiment, the first moisture content is about 1 wt % to about 3 wt %. Under one embodiment, the first moisture content is about 0.5 wt % to about 1 wt %.

Under one embodiment, the lignocellulose particles is added into a mixer or blender, such as a rotatable drum blender. Vegetable C₁₋₄ alkyl ester and polysiloxane mixture can be added onto the lignocellulose particles and then agitated to produce a mixture containing at least the lignocellulose particles and vegetable C₁₋₄ alkyl ester and polysiloxane mixture. Subsequently, binder resin can be added to the mixture and further agitated to produce a mixture containing at least the lignocellulose particles, vegetable C₁₋₄ alkyl ester and polysiloxane mixture, and binder resin. The moisture content of the mixture can be measured and recorded as a second moisture content. In some embodiments, the second moisture content can be about 2 wt % to about 10 wt %. Under one embodiment, the second moisture content is about 2 wt % to about 10 wt %. Under one embodiment, the second moisture content is about 4 wt % to about 10 wt %. Under one embodiment, the second moisture content is about 6 wt % to about 10 wt %. Under one embodiment, the second moisture content is about 8 wt % to about 10 wt %. Under one embodiment, the second moisture content is about 2 wt % to about 8 wt %. Under one embodiment, the second moisture content is about 4 wt % to about 8 wt %. Under one embodiment, the second moisture content is about 6 wt % to about 8 wt %. Under one embodiment, the second moisture content is about 2 wt % to about 6 wt %. Under one embodiment, the second moisture content is about 4 wt % to about 6 wt %. Under one embodiment, the second moisture content is about 2 wt % to about 4 wt %.

In one or more embodiments, based on the differences in the first and second moisture contents, a designated amount of the mixture containing the lignocellulose particles, vegetable C₁₋₄ alkyl ester and polysiloxane mixture, and binder resin can be shaped into a mat of the mixture. The mats can be pressed and heated for a predetermined amount of time to at least partially cure the binder resin composition and produce the lignocellulose composite product. In some embodiments, the mats can be pressed at a pressure of about 7 bar to about 50 bar, about 30 bar to about 50 bar, or about 30 bar to about 50 bar at a temperature of about 90° C. to about 500° C., about 100° C. to about 400° C., about 138° C. to about 250° C., about 149° C. to about 232° C., about 121° C. to about 316° C., or about 149° C. to about 210° C. for a time period of about 30seconds (s) to about 15 minutes (min) or about 1 min to about 10 min or about 1 min to about 5 min.

For example, the mats can be pressed and heated at a pressure of about 6.9 bar, about 7 bar, about 8 bar, about 9 bar, about 10 bar, about 11 bar, about 12 bar, about 13 bar, about 14 bar, about 15 bar, about 16 bar, about 17 bar, about 18 bar, about 19 bar, about 15 bar, about 20 bar, about 21 bar, about 22 bar, about 23 bar, about 24 bar, about 25 bar, about 26 bar, about 27 bar, about 28 bar, about 29 bar, about 30 bar, about 31 bar, about 32 bar, about 33 bar, or about 34 bar to about 35 bar, about 36 bar, about 37 bar, about 38 bar, about 39 bar, about 40 bar, about 41 bar, about 42 bar, about 43 bar, about 44 bar, about 45 bar, about 46 bar, about 47 bar, about 48 bar, about 49 bar, about 50 bar, about 51 bar, or about 52 bar, or greater, depending on the specific type of composite product to be produced, as well as the density and/or dimensions of the produced composite product. In some examples, the mats can be pressed and heated at a temperature of about 90° C., about 95° C., about 100° C., about 110° C., about 120° C., about 130° C., about 140° C., or about 150° C. to about 160° C., about 170° C., about 180° C., about 190° C., about 200° C., about 210° C., about 220° C., about 230° C., about 240° C., about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., about 400° C., about 410° C., about 420° C., about 430° C., about 440° C., about 450° C., about 460° C., about 470° C., about 480° C., about 490° C., about 500° C., or greater, depending on the specific type of composite product to be produced, as well as the density and/or dimensions of the produced composite product.

In some examples, the mats can be pressed and heated for about 5 s, about 10 s, about 15 s, about 20 s, about 25 s, about 30 s, about 35 s, about 40 s, about 45 s, about 50 s, about 55 s, about 60 s, about 65 s, about 70 s, about 75 s, about 80 s, about 85 s, about 90 s, about 95 s, about 100 s, about 105 s, about 110 s, about 115 s, about 2 min, about 2.5 min, about 3 min, about 3.5 min, about 4 min, about 4.5 min, about 5 min, about 5.5 min, about 6 min, about 6.5 min, about 7 min, about 7.5 min, about 8 min, about 8.5 min, about 9 min, about 9.5 min, about 10 min, about 10.5 min, about 11 min, about 11.5 min, about 12 min, about 12.5 min, about 13 min, about 13.5 min, about 14 min, about 14.5 min, about 15 min, about 16 min, about 17 min, about 18 min, about 19 min, about 20 min, or greater, depending on the specific type of composite product to be produced, as well as the density and/or dimensions of the produced composite product. For example, the mats can be pressed and heated for about 5 s to about 30 s, about 30 s to about 1 min, about 30 s to about 2 min, about 30 s to about 3 min, about 30 s to about 4 min, about 30 s to about 5 min, about 30 s to about 6 min, about 30 s to about 7 min, about 30 s to about 8 min, about 30 s to about 9 min, about 30 s to about 10 min, about 30 s to about 15 min, about 1 min to about 5 min, about 1 min to about 10 min, about 2 min to about 6 min, about 5 min to about 15 min, or about 5 min to about 10 min, depending on the specific type of composite product to be produced, as well as the density and/or dimensions of the produced composite product.

In one or more embodiments, a method for producing the lignocellulose composite product can include contacting or combining the plurality of lignocellulose particles with vegetable C₁₋₄ alkyl ester and polysiloxane mixture and binder resin to produce a mixture. The method can also include at least partially curing the binder resin within the mixture to produce the hydrophobized, lignocellulose composite product. Generally, the mixture produced by contacting or combining the lignocellulose particles, mixture of vegetable C₁₋₄ alkyl ester and polysiloxane, and the binder resin can be in a solid-state, a liquid state, a wax form, a powder form, a solution, a suspension, a slurry, an emulsion, or an inverse emulsion, and can be in a single phase or have multiple phases. Illustrative processes or techniques that can be used to combine or contact the lignocellulose particles, the mixture of vegetable C₁₋₄ alkyl ester and polysiloxane, and/or the binder resin can include spraying, coating, agitating, mixing, stirring, blending, tumbling, sonication or vibration, brushing, falling film or curtain coater, dipping, soaking, extrusion, or the like.

The lignocellulose particles, the mixture of vegetable C₁₋₄ alkyl ester and polysiloxane, and the binder resin can be combined or contacted with each other in any order or at the same time to produce the mixture. In one example, the lignocellulose particles can be first combined or otherwise contacted with the mixture of vegetable C₁₋₄ alkyl ester and polysiloxane, and then combined or otherwise contacted with the binder resin to produce the mixture. In another example, the lignocellulose particles can be first combined or otherwise contacted with the binder resin, and then combined or otherwise contacted with the mixture of vegetable C₁₋₄ alkyl ester and polysiloxane to produce the mixture. In another example, the lignocellulose particles, the mixture of vegetable C₁₋₄ alkyl ester and polysiloxane, and the binder resin can be combined or contacted together at substantially the same time to produce the mixture.

In another embodiment, a lignocellulose composite product can include the plurality of lignocellulose particles, vegetable C₁₋₄ alkyl ester and polysiloxane mixture, and one or more at least partially cured binder resins. The mixture of vegetable C₁₋₄ alkyl ester and polysiloxane can include about 30 wt % to about 98 wt % of the one or more fatty acid compounds, about 0.1 wt % to about 15 wt % of the one or more rosin acid compounds, and about 1 wt % to about 40 wt % of one or more unsaponifiable compounds. In some examples, prior to curing the binder resin, the uncured binder resin can include an aldehyde-based resin and a copolymer having one or more unsaturated carboxylic acids, one or more unsaturated carboxylic anhydrides, or a combination thereof, and one or more vinyl aromatic derived units. The aldehyde-based resin can include one or more of a urea-aldehyde resin, a melamine-aldehyde resin, a phenol-aldehyde resin, a resorcinol-aldehyde resin, a phenol-resorcinol-aldehyde resin, a melamine-urea-aldehyde resin, a phenol-melamine-urea-aldehyde resin, a phenol-urea-aldehyde resin, or any combination thereof.

The lignocellulose composite product can be formed into a variety of different fiber-containing composite products, wood-containing composite products, or a mixture thereof. Illustrative fiber and/or wood containing composite products, such as the lignocellulose composite products, can include, but are not limited to, orientated strand boards (OSB), particleboards, high density fiberboards (HDF), medium density fiberboards (MDF), or low density fiberboards (LDF), or other types of fiberboards.

The lignocellulose composite product can have a water absorption of about 60 wt % or less, about 55 wt % or less, about 50 wt % or less, about 45 wt % or less, about 44 wt % or less, about 43 wt % or less, about 42 wt % or less, about 41 wt % or less, about 40 wt % or less, about 39 wt % or less, about 38 wt % or less, about 37 wt % or less, about 36 wt % or less, about 35 wt % or less, about 34 wt % or less, about 33 wt % or less, about 32 wt % or less, about 31 wt % or less, about 30 wt % or less, about 29 wt % or less, about 28 wt % or less, about 27 wt % or less, about 26 wt % or less, about 25 wt % or less, about 24 wt % or less, about 23 wt % or less, about 22 wt % or less, about 21 wt % or less, about 20 wt % or less, about 15 wt % or less, about 10 wt % or less, as measured according to the Water Absorption and Thickness Swelling Test under ASTM D1037-96a. In some examples, the lignocellulose composite product can have a water absorption of about 10 wt % to about 60 wt %, about 15 wt % to about 55 wt %, about 20 wt % to about 50 wt %, about 20 wt % to about 45 wt %, about 20 wt % to about 40 wt %, or about 20 wt % to about 35 wt %, as measured according to the Water Absorption and Thickness Swelling Test under ASTM D1037-96a.

The lignocellulose composite product can have a thickness swelling of about 40 wt % or less, about 35 wt % or less, about 30 wt % or less, about 25 wt % or less, about 24 wt % or less, about 23 wt % or less, about 22 wt % or less, about 21 wt % or less, about 20 wt % or less, about 19 wt % or less, about 18 wt % or less, about 17 wt % or less, about 16 wt % or less, about 15 wt % or less, about 14 wt % or less, about 13 wt % or less, about 12 wt % or less, about 11 wt % or less, about 10 wt % or less, about 9 wt % or less, about 8 wt % or less, about 7 wt % or less, about 6 wt % or less, or about 5 wt % or less, as measured according to the Water Absorption and Thickness Swelling Test under ASTM D1037-96a. In some examples, the lignocellulose composite product can have a thickness swelling of about 5 wt % to about 30 wt %, about 10 wt % to about 25 wt %, about 11 wt % to about 25 wt %, about 12 wt % to about 25 wt %, about 13 wt % to about 25 wt %, about 14 wt % to about 25 wt %, about 15 wt % to about 25 wt %, about 16 wt % to about 25 wt %, about 17 wt % to about 25 wt %, about 18 wt % to about 25 wt %, about 19 wt % to about 25 wt %, or about 20 wt % to about 25 wt %, as measured according to the Water Absorption and Thickness Swelling Test under ASTM D1037-96a.

In some examples, the lignocellulose composite product can have a water absorption of about 50 wt % or less and a thickness swelling of about 15 wt % or less, as measured according to the Water Absorption and Thickness Swelling Test under ASTM D1037-96a. In other examples, the water absorption can be about 40 wt % or less and the thickness swelling can be about 10 wt % or less, as measured according to the Water Absorption and Thickness Swelling Test under ASTM D1037-96a. In other examples, the water absorption can be about 30 wt % or less and the thickness swelling can be about 10 wt % or less, as measured according to the Water Absorption and Thickness Swelling Test under ASTM D1037-96a. In other examples, the water absorption can be about 20 wt % or less and the thickness swelling can be about 5 wt % or less, as measured according to the Water Absorption and Thickness Swelling Test under ASTM D1037-96a.

The lignocellulose composite product has a density of about 0.4 g/cm³ to about 1 g/cm³. Under one embodiment, The lignocellulose composite product has a density of about 0.4 g/cm³ to about 1.0 g/cm³. Under one embodiment, The lignocellulose composite product has a density of about 0.5 g/cm³ to about 1.0 g/cm³. Under one embodiment, The lignocellulose composite product has a density of about 0.6 g/cm³ to about 1.0 g/cm³. Under one embodiment, The lignocellulose composite product has a density of about 0.7 g/cm³ to about 1.0 g/cm³. Under one embodiment, The lignocellulose composite product has a density of about 0.8 g/cm³ to about 1.0 g/cm³. Under one embodiment, The lignocellulose composite product has a density of about 0.9 g/cm³ to about 1.0 g/cm³. Under one embodiment, The lignocellulose composite product has a density of about 0.4 g/cm³ to about 0.9 g/cm³. Under one embodiment, The lignocellulose composite product has a density of about 0.5 g/cm³ to about 0.9 g/cm³. Under one embodiment, The lignocellulose composite product has a density of about 0.6 g/cm³ to about 0.9 g/cm³. Under one embodiment, The lignocellulose composite product has a density of about 0.7 g/cm³ to about 0.9 g/cm³. Under one embodiment, The lignocellulose composite product has a density of about 0.8 g/cm³ to about 0.9 g/cm³. Under one embodiment, The lignocellulose composite product has a density of about 0.4 g/cm³ to about 0.8 g/cm³. Under one embodiment, The lignocellulose composite product has a density of about 0.5 g/cm³ to about 0.8 g/cm³. Under one embodiment, The lignocellulose composite product has a density of about 0.6 g/cm³ to about 0.8 g/cm³. Under one embodiment, The lignocellulose composite product has a density of about 0.7 g/cm³ to about 0.8 g/cm³. Under one embodiment, The lignocellulose composite product has a density of about 0.4 g/cm³ to about 0.7 g/cm³. Under one embpdment, The lignocellulose composite product has a density of about 0.5 g/cm³ to about 0.7 g/cm³. Under one embodiment, The lignocellulose composite product has a density of about 0.6 g/cm³ to about 0.7 g/cm³. Under one embodiment, The lignocellulose composite product has a density of about 0.4 g/cm³ to about 0.6 g/cm³. Under one embodiment, The lignocellulose composite product has a density of about 0.5 g/cm³ to about 0.6 g/cm³. Under one embodiment, The lignocellulose composite product has a density of about 0.4 g/cm³ to about 0.5 g/cm³.

The lignocellulose composite product can have any appropriate thickness, between about 0.1 cm and about 4.0 cm. Under one embodiment, The lignocellulose composite product has a thickness between about 0.1 cm and about 4.0 cm. Under one embodiment, the lignocellulose composite product has a thickness between about 0.1 cm and about 4.0 cm. Under one embodiment, the lignocellulose composite product has a thickness between about 0.3 cm and about 4.0 cm. Under one embodiment, the lignocellulose composite product has a thickness between about 0.5 cm and about 4.0 cm. Under one embodiment, the lignocellulose composite product has a thickness between about 1.0 cm and about 4.0 cm. Under one embodiment, the lignocellulose composite product has a thickness between about 2.0 cm and about 4.0 cm. Under one embodiment, the lignocellulose composite product has a thickness between about 0.1 cm and about 2.0 cm. Under one embodiment, the lignocellulose composite product has a thickness between about 0.3 cm and about 2.0 cm. Under one embodiment, the lignocellulose composite product has a thickness between about 0.5 cm and about 2.0 cm. Under one embodiment, the lignocellulose composite product has a thickness between about 1.0 cm and about 2.0 cm. Under one embodiment, the lignocellulose composite product has a thickness between about 0.1 cm and about 1.0 cm. Under one embodiment, the lignocellulose composite product has a thickness between about 0.3 cm and about 1.0 cm. Under one embodiment, the lignocellulose composite product has a thickness between about 0.5 cm and about 1.0 cm. Under one embodiment, the lignocellulose composite product has a thickness between about 0.1 cm and about 0.5 cm. Under one embodiment, the lignocellulose composite product has a thickness between about 0.3 cm and about 0.5 cm. Under one embodiment, the lignocellulose composite product has a thickness between about 0.1 cm and about 0.3 cm.

The lignocellulose composite product can have an internal bond strength of about 621 kPa, about 627 kPa, about 634 kPa, about 641 kPa, about 648 kPa, about 655 kPa, about 662 kPa, about 669 kPa, about 676 kPa, about 683 kPa, or about 689 kPa to about 696 kPa, about 703 kPa, about 710 kPa, about 717 kPa, about 724 kPa, about 731 kPa, about 738 kPa, about 745 kPa, about 752 kPa, about 758 kPa, or greater. In some examples, the lignocellulose composite product can have an internal bond strength of about 621 kPa to about 758 kPa, about 655 kPa to about 724 kPa, about 662 kPa to about 717 kPa, about 669 kPa to about 710 kPa, about 676 kPa to about 703 kPa, about 683 kPa to about 696 kPa, or about 689 kPa to about 758 kPa. The internal bond strength for each example can be determined according to the test procedure provided for in ASTM D1037-96a.

The present invention is also directed to a formulation comprising the mixture of vegetable C₁₋₄ alkyl ester and binder resin for the use in porous particles. This may be used as a coating or durable protection of various porous substrates, including wood, wood products, paper, concrete, mortar, stone, open-celled foam, and like.

### Experimental

The soy methyl ester is from Solvent Systems International (Elk Grove Village, Illinois, USA). The soy methyl ester comprises about 10 wt % palmitic methyl ester, about 4 wt % stearic methyl ester, about 25 wt % oleic methyl ester, 53 wt % linoleic methyl ester, and 8 wt % linolenic methyl ester.

GP-426 is a hydroxyl-terminated dimethyl polysiloxane fluid with a nominal viscosity of 100 cSt at 25° C., that has the formula HO—[SiMe₂—O—]ₓ—SiMe₂—OH, and is available from Genesee Polymers Corporation (Burton, Mich., USA).

GP-422 is a concentrated 75 wt %: 25 wt % mixture of a reactive, further curable silicone resin in a octamethylcyclotetrasiloxane/decamethylcyclotetrasiloxane carrier, available from Genesee Polymers Corporation.

GP-7100 is an amine-alkyl modified methylalkylaryl silicone copolymer of formula Me₃S—[—SiMeR—O]ₓ—SiMe3, wherein R is a mixture of —C₁₂H₂₅, —CH₂CHMePh, and —(CH₂)₃—NH₂, with CAS No. 109037-71-0. It is available from Genesee Polymers Corporation.

GP-965 is an aminopropyl terminated polydimethylsiloxane, of formula H₂N—(CH₂)₃—[SiMe₂—O]ₓ—SiMe₂—(CH₂)₃—NH₂, wherein x=10, with CAS No. 106214-84-0. GP-965 is suitable for use as a component in the synthesis of silicone—organic block copolymers. GP-965 is compatible with dimethyl silicone fluids, and with aliphatic, aromatic and chlorinated solvents. GP-965 is available from Genesee Polymers Corporation.

TP-5000N is TEGO® Protect 5000 N, which is a solvent-free, hydroxy-functional polydimethylsiloxane, that has an outstanding hydro- and oleophobic properties for 2-pack coatings based on acrylic/isocyanate and polyester/isocyanate applications. TEGO® Protect 5000 N is dilutable by esters, ketones and glycol ethers, and is available from Evonik Industries (Essen, Germany).

PMDI is polymeric diphenylmethane diisocyanate, such as Wannate PM-200 polymeric diphenylmethane diisocyanate, available from Wanhua Chemical America Co. Ltd. (Newtown Square, Pa., USA).

nfPDMS is a non-functionalized polydimethylsiloxane, which has the formula Me₃Si—O—[SiMe₂—O]ₓ—SiMe₃, and was obtained from ChemicalStore.com.

PS-68-4 is a moisture cure polyurethane adhesive obtained from Polymer Synergies (Mantua, N.J., USA).

PSES-2 is a polyurethane edge seal based on soy methyl ester.

### Experiment 1

In the first experiment, the compatibility of the soy methyl ester with various silicones and ratios thereof was investigated. Seven formulations, each of about 200 mL, were mixed, as shown in Table 1.

TABLE 1
Soy methyl ester - silicone mixtures

| Example | | |
|---|---|---|
| No. | Formulation | Observations |
| 1 | 50% SME:50% GP-426 | Clear yellow liquid |
| 2 | 75% SME:25% GP-426 | Clear yellow liquid |
| 3 | 50% SME:50% GP-422 | Clear yellow liquid |
| 4 | 75% SME:25% GP-422 | Clear yellow liquid |
| 5 | 75% SME:25% GP-7100 | Clear yellow/orange liquid |
| 6 | 75% SME:25% TP-5000N | Clear pale yellow liquid |
| 7 | 50% SME:50% nfPDMS | Phase separates into two layers |

The data in Table 1 suggest that SME is a good solvent for functionalized silicone polymers. The resultant solutions are clear and stable.

When SME was mixed with a non-functionalized polydimethylsiloxane, a cloudy yellow mixture is formed, which phase separates into two layers. This observation suggests that SME is not compatible with a non-functionalized polydimethylsiloxane

### Experiment 2

In the second experiment, the compatibility of soy methyl ester with various components typically used in engineering wood composite formulations was investigated. Three formulations, each of about 200 mL, were mixed as shown in Table 2.

TABLE 2
Soy methyl ester solutions

| Example | | |
|---|---|---|
| No. | Formulation | Observations |
| 8 | 50% SME:50% PMDI | Clear yellow/orange liquid |
| 9 | 50% SME:50% PS-68-4 | Clear yellow liquid |
| 10 | 50% SME:50% PSES-2 | Slightly cloudy yellow liquid |

Table 2 suggests that SME is compatible with selected compositions used in wood composites. The ability to have stable solutions with PMDI or polyurethane polymers indicates that SME may be used in the making of other products like edge seal coatings for use in OSB and plywood.

### Experiment 3

In the third experiment, the use of mixtures of soy methyl ester and functionalized polydimethylsiloxanes in a particle board was investigated. Examples 11 and 12 are comparative examples that contain no SME/fPDMS, and Examples 13 and 14 contain SME/fPDMS at 2 wt %.

A board of Example 11 was prepared by applying 44.44 grams of Wannate PM-200 polymeric diphenylmethane diisocyanate to 1200 grams of wood (moisture content of 8%). The PMDI was applied to wood particles tumbling in a rotary blender by atomizing the PMDI by the use of a Central Pneumatics High Volume Low Pressure gravity feed air spray gun.

A board of Example 12 was prepared in a similar manner as the board of Example 12, except that 22.22 grams of PMDI were used.

The board of working Example 13 was made in two steps. First, 11.11 grams of 75:25 mixture of soy methyl ester and functionalized dimethylpolysiloxane GP-422 was applied to wood particles tumbling in a rotary blender using a Central Pneumatics HVLP gravity feed air spray gun. Second, to such treated wood particles was added 22.22 grams of Wannate PM-200. The PMDI was applied in a similar manner as in Examples 11 and 12.

The board of working Example 14 was prepared in a similar manner as that of Example 13, except that functionalized dimethylpolysiloxane GP-426 was used in place of GP-422.

The boards were pressed using typical procedures.

After the boards were pressed they were allowed to equilibrate for three days in the laboratory prior to cutting. Two centimeters were trimmed from each edge of the board to remove the low density edges which occur as a result of the pressing of the boards. The boards were then cut into samples approximately 9 cm×2 cm for soak studies. The density of the samples was measured prior to soaking to ensure that each comparative sample had approximately the same density.

The formulations and densities of boards of Examples 11 to 14 are presented in Table 3.

TABLE 3
Soy methyl ester—silicone mixtures

| Ex- | | | GP- | GP- | | | | |
|---|---|---|---|---|---|---|---|---|
| ample | Wood | SME | 422 | 426 | PMDI | Sili- | Density | Density |
| No. | (g) | (g) | (g) | (g) | (g) | cone | (lb/ft³) | (g/mL) |
| 11 | 1200 | | | | 44.44 | 0 | 49.03 | 0.785 |
| 12 | 1200 | | | | 22.22 | 0 | 48.77 | 0.781 |
| 13 | 1200 | 8.33 | 2.78 | | 22.22 | 0.25% | 47.49 | 0.761 |
| 14 | 1200 | 8.33 | | 2.78 | 22.22 | 0.25% | 48.58 | 0.778 |

After the densities were matched, the samples were reweighed, and the weights recorded. The samples were then placed into a 7.5 inch×9.5 inch×3.0 inch (19 cm×24 cm×8 cm) polyethylene pan, which contained 2-liters of water. The samples were kept submerged in the water by using a weighted aluminum screen. Sample weights were measured as a function of soak time by taking the samples out of the water, blotting them dry, and weighing the samples and recording the weight change. The samples were then returned to the water after each measurement for continued soaking, and for subsequent measurements as a function of soak time. Measurements were recorded as shown in Table 4.

TABLE 4
Percent Weight Change of Soaked Wood Samples

| Time | Example | Example | Example | Example |
|---|---|---|---|---|
| (h) | No. 11 | No. 12 | No. 13 | No. 14 |
| 0.25 | 22.2 | 11.1 | 5.6 | 5.6 |
| 0.50 | 46.7 | 19.3 | 7.1 | 7.1 |
| 0.75 | 57.8 | 27.8 | 8.9 | 8.9 |
| 1 | 65.6 | 34.4 | 10.9 | 10.9 |
| 2 | 69.6 | 51.1 | 15.3 | 15.3 |
| 4 | 70.0 | 58.9 | 21.1 | 22.2 |
| 8 | 72.4 | 64.4 | 31.1 | 31.1 |
| 16 | 76.7 | 67.8 | 45.6 | 45.6 |
| 24 | 80.0 | 68.9 | 48.0 | 50.0 |

The weight of the water absorbed is shown in Table 5.

TABLE 5
Weight of Water Absorbed by Soaked Wood Samples

| Time | Example | Example | Example | Example |
|---|---|---|---|---|
| (h) | No. 11 | No. 12 | No. 13 | No. 14 |
| 0.25 | 0.48 | 0.94 | 2.92 | 2.92 |
| 0.50 | 0.73 | 1.46 | 5.83 | 5.83 |
| 0.75 | 0.94 | 1.92 | 6.67 | 6.67 |
| 1 | 1.15 | 2.38 | 7.19 | 7.19 |
| 2 | 1.56 | 3.85 | 7.60 | 7.60 |
| 4 | 2.29 | 5.21 | 7.81 | 7.81 |
| 8 | 3.40 | 6.35 | 8.08 | 8.08 |
| 16 | 4.83 | 7.54 | 8.46 | 8.46 |
| 24 | 5.31 | 6.77 | 8.65 | 8.65 |

The data in Tables 4 and 5 show several trends. Firstly, the board samples which contain the silicone (Examples 13 and 14) have a more gradual weight change than the board samples which do not contain the silicone (Examples 11 and 12). This would suggest that silicone retards water absorption rate into the board.

Secondly, the final percent weight change after 24 hours for the board samples which contain the silicone (Examples 13 and 14) is dramatically reduced. There is approximately a 39 percent reduction in weight change for samples containing the silicone as compared to the control sample with the same amount (2%) of PMDI binder. Further, there is approximately a 29 percent reduction in weight change for samples containing the silicone as compared to the control sample with twice the amount (4%) of PMDI binder. This suggests that the presence of silicone lowers the steady state of the total amount of the water absorbed.

Thirdly, there does not appear to be much of a difference between Examples 13 and 14. The small differences are likely due to variation of the sampling technique, rather than due to significant differences.

### Experiment 4

In the fourth experiment, the use of different functionalized silicone polymer in particleboards was investigated. Using similar methods as described in Experiment 3, particleboards using a 75 : 25 blend of soy methyl ester and hydroxy terminated polydimethylsiloxane Tego Protect 5000N were prepared. The formulation of Examples 15 and 16 are boards comprising no silicone polymer, and 4 wt % and 2 wt % PMDI, respectively. The formulation of Example 17 comprises 0.25 wt % Tego Protect 5000N and 2 wt % PMDI.

Samples were prepared as described in Experiment 3, and the density of the samples was measured prior to soaking to ensure that each comparative sample had approximately the same density.

The formulations and densities of boards of Examples 15 to 17 are presented in Table 6.

TABLE 6
Soy methyl ester—silicone mixtures

| | | | TP- | | | | |
|---|---|---|---|---|---|---|---|
| Example | Wood | SME | 5000N | PMDI | Sili- | Density | Density |
| No. | (g) | (g) | (g) | (g) | cone | (lb/ft³) | (g/mL) |
| 15 | 1200 | | | 44.44 | 0 | 47.67 | 0.764 |
| 16 | 1200 | | | 22.22 | 0 | 47.17 | 0.756 |
| 17 | 1200 | 8.33 | 2.78 | 22.22 | 0.25% | 49.07 | 0.761 |

The samples were treated as in Experiment 3. The percent weight change is shown in Table 7.

TABLE 7
Percent Weight Change of Soaked Wood Samples

| Time | Example | Example | Example |
|---|---|---|---|
| (h) | No. 15 | No. 16 | No. 17 |
| 0.25 | 33.3 | 9.1 | 4 |
| 0.50 | 60.5 | 15.1 | 6 |
| 0.75 | 68.3 | 20.2 | 8.1 |
| 1 | 71.6 | 26.2 | 11.1 |
| 2 | 75.2 | 42.3 | 16.1 |
| 4 | 79.6 | 58.1 | 25.2 |
| 8 | 83.7 | 64.5 | 40.3 |
| 16 | 85.7 | 70.6 | 56.5 |
| 24 | 86.7 | 73.8 | 59.3 |

The weight of the water absorbed is shown in Table 8.

TABLE 8
Weight Change of Soaked Wood Samples

| Time | Example | Example | Example |
|---|---|---|---|
| (h) | No. 15 | No. 16 | No. 17 |
| 0.25 | 3.36 | 0.93 | 0.56 |
| 0.50 | 6.09 | 1.59 | 0.75 |
| 0.75 | 6.92 | 2.15 | 0.93 |
| 1 | 7.23 | 2.8 | 1.4 |
| 2 | 7.66 | 4.49 | 1.78 |
| 4 | 8.04 | 6.07 | 2.73 |
| 8 | 8.34 | 6.84 | 4.39 |
| 16 | 8.69 | 7.53 | 5.89 |
| 24 | 9.08 | 7.85 | 6.36 |

The data in Tables 7 and 8 show similar trends as in Experiment 3. These observations, as well as comparison to Tables 4 and 5, show several trends.

Firstly, the board sample which contains the silicone (Example 17) has a more gradual weight change than the board samples which do not contain the silicone (Examples 15 and 16). This would suggest that silicone retards water absorption rate into the board.

Secondly, the final percent weight change after 24 hours for the board sample which contains the silicone (Example 17) is dramatically reduced. There is approximately a 33 percent reduction in weight change for samples containing the silicone as compared to the control sample with the same amount (2%) of the PMDI binder. Further, there is approximately a 20 percent reduction in weight change for samples containing the silicone as compared to the control sample with twice the amount (4%) of the PMDI binder. This suggests that the presence of silicone lowers the steady state of the total amount of the water absorbed.

Thirdly, there does not appear to be much of a difference between Examples 13, 14, and 17. This suggests that the differences between silicone polymer formulations have little effect on the effectiveness of the hydrophobic effect.

### Experiment 5

In the fifth experiment, the use of partial substitution of untreated wood used to make particle boards with high-loading silicone-treated wood was investigated.

The board of Example 18 (control) was made of wood particles and PMDI without the use of any silicone polymer.

High-load silicone-treated wood for use in the preparation of a board of Example 19, was made by mixing 100 grams of wood particles with 100 grams of amine functional silicone fluid GP-965 using a high shear, dry blending process.

High-load silicone-treated wood for use in the preparation of a board of Example 20 was made by mixing 100 grams of wood particles with 100 grams of hydroxyl-terminated dimethyl polysiloxane fluid GP-426, using a high shear, dry blending process.

The boards of Examples 18, 19, and 20, were prepared in a rotary blender using Wanate PM-200 polymeric methylenediphenyl diisocyanate as the binder resin. The PMDI was applied to the wood tumbling in a rotary blender using a Central Pneumatics HVLP spray gun. The control boards had 4 percent PMDI added based on the oven dry weight of wood.

For boards of Examples 19 and 20, 10% of the untreated wood was substituted with the high-load silicone-treated wood. The amount of PMDI binder resin added to the comparative boards was 4 percent PMDI based on the oven dry weight of wood. The moisture content for all wood is 8 wt %.

Samples were prepared as described in Experiment 3 and the density of the samples were measured prior to soaking to ensure that each comparative sample had approximately the same density.

The formulations of boards of Examples 18 to 20 are presented in Table 9.

TABLE 9
10% Substitution of high-load silicone-treated wood particles

| | | 50:50 | 50:50 | | |
|---|---|---|---|---|---|
| | Untreated | wood:GP- | wood:GP- | | |
| Example | Wood | 965 | 426 | PMDI | |
| No. | (g) | (g) | (g) | (g) | Silicone |
| 18 | 1200 | | | 44.44 | 0 |
| 19 | 1080 | 120 | | 22.22 | 0.25 wt % |
| 20 | 1080 | | 120 | 22.22 | 0.25 wt % |

The samples were cut and soak studies were performed in the same manner as in Experiment 3 or 4. The results of the soak studies, as a percent weight change of the sample boards, is shown in Table 10.

TABLE 10
Percent Weight Change of Soaked Wood Samples

| Time | Example | Example | Example |
|---|---|---|---|
| (h) | No. 18 | No. 19 | No. 20 |
| 0.25 | 15.1 | 14.7 | 4 |
| 0.50 | 25.9 | 21.5 | 6.4 |
| 0.75 | 38.8 | 29.1 | 8 |
| 1 | 47.8 | 33.9 | 9.6 |
| 2 | 69.1 | 47.8 | 15.5 |
| 4 | 74.9 | 60.6 | 19.1 |
| 8 | 79.7 | 65.7 | 27.9 |
| 16 | 83.7 | 71.7 | 40.4 |
| 24 | 85.7 | 73.7 | 46.8 |

The data in Table 10 shows several trends.

Firstly, the board samples which contain the wood particles with silicones (Examples 19 and 20) have a lower rate of weight change than the control board sample which does not contain the silicone (Example 18), even though the control board sample contains twice as much PMDI binder. This would suggest that the use of wood particles with high load of silicone retards the water absorption rate into the board.

Secondly, the final percent weight change after 24 hours for the board sample which contains the silicone (Examples 19 and 20) is reduced compared to the control board which does not contain silicone (Example 18). There is approximately a 45 percent reduction in the weight change for sample containing wood particles with silicone GP426 as compared to the control sample with twice the amount of the PMDI binder. Further, there is approximately a 15 percent reduction in weight change for samples containing wood particles with silicone GP965 as compared to the control sample with twice the amount of the PMDI binder. This suggests that the presence of wood particles with silicone lowers the steady state of the total amount of the water absorbed.

Thirdly, there appears to be a significant difference between the reduction percent weight change of the board sample that comprises wood particles with silicone GP-426 and the reduction percent weight change of the board sample that comprises wood particles with silicone GP-965. This suggests that the differences between silicone polymer formulations may have a significant effect on the effectiveness of the hydrophobic effect.

### Experiment 6

In the sixth experiment, the use of soy methyl ester as a solvent with a polyurethane edge sealer for use on an oriented strand board was investigated. In this experiment, 23/32 in nominal (actual width of 0.703 inches, 18.6 mm) OSB flooring panel was purchased from the Home Depot (Atlanta, Georgia, USA) and cut into 6 in x 6 in sample boards. Four formulations of Example Nos. 22 to 25 comprising polyurethane edge sealers ES-1 to ES-4 (available from Polymer Synergies, Mantua, N.J., USA) dispersed in SME were prepared. The sample board of Example No. 21 was left uncoated. Three edges of sample boards of Example Nos. 22 to 25 were coated with a 2 to 3 mil (0.5 to 0.8 mm) layer the SME/PU formulated edge sealer and were allowed to dry for 24 hours.

The weight and the mean edge thickness were measured for each sample board. Each of the boards was placed on one edge into a pan of water containing green food coloring to help show water ingress, and measured over time.

The percent edge thickness swell as a function of time is shown in Table 11.

TABLE 11
Percent of Edge Weight Change of Soaked Wood Samples

| Time | Example | Example | Example | Example | Example |
|---|---|---|---|---|---|
| (h) | No. 21 | No. 22 | No. 23 | No. 24 | No. 25 |
| 6 | 16.0 | 0.8 | <0.1 | 1.2 | <0.1 |
| 24 | 22.7 | 3.6 | 0.1 | 3.2 | 1.3 |

The percent water absorption as a function of time is shown in Table 12.

TABLE 12
Percent of Edge Weight Change of Soaked Wood Samples

| Time | Example | Example | Example | Example | Example |
|---|---|---|---|---|---|
| (h) | No. 21 | No. 22 | No. 23 | No. 24 | No. 25 |
| 6 | 7.2 | 0.4 | 0.3 | 0.7 | 0.5 |
| 12 | 10.3 | 0.8 | 0.5 | 1.1 | 0.7 |
| 24 | 14.4 | 1.3 | 0.9 | 1.8 | 1.1 |

The data in Tables 11 and 12 show that there is a significant reduction of the use of polyurethane edge sealers that have been diluted with SME. This suggests that SME works well as a diluents for polyurethane edge sealers.

While the present invention has been described with reference to several embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention is to be determined from the claims appended hereto. Further, it will be apparent to those of skill in the art that numerous changes may be made in such details without departing from the spirit and the principles of the invention.

What is claimed is:

1. A wax substitute composition comprising:
(a) about 5 wt % to about 95 wt % of a vegetable C₁₋₄ alkyl ester; and
(b) about 5 wt % to about 95 wt % of a polysiloxane.

2. The composition of claim 1, wherein the C₁₋₄ alkyl is methyl.

3. The composition of claim 2, wherein the vegetable methyl ester is selected from the group consisting of avocado methyl ester, canola methyl ester, coconut methyl ester, corn methyl ester, cottonseed methyl ester, flaxseed methyl ester, grape seed methyl ester, hemp seed methyl ester, linseed methyl ester, olive methyl ester, palm methyl ester, peanut methyl ester, safflower methyl ester, soybean methyl ester, sunflower methyl ester, and mixtures thereof.

4. The composition of claim 2, wherein the vegetable methyl ester is selected from the group consisting of cottonseed methyl ester, corn methyl ester, flaxseed methyl ester, linseed methyl ester, soybean methyl ester, sunflower methyl ester, and mixtures thereof.

5. The composition of claim 2, wherein the vegetable methyl ester is soybean methyl ester.

6. The composition of claim 1, wherein the polysiloxane are terminated with one or more ligands selected from the group consisting of halide, —Cl, —Br, aminoalkyl, —(CH₂)ₐNH₂, hydroxyl, —OH, vinyl, —CH═CH₂, glycidyl ether, —(CH₂)_{b}—O—(CH₂)_{c}—OH, —(CH₂)_{d}—O—(CH₂)ₑ-cyclo(C₂H₃O), epoxycyclohexylethyl, —(CH₂)₂—(C₆H₉O), acrylamidoalkyl, —(CH₂)_{f}N—CO—CH═CH₂, and mixtures thereof;
wherein a, b, c, d, e, f and g each independently are 0 to 3.

7. The composition of claim 1, wherein the polysiloxane are terminated with one or more ligands selected from the group consisting of hydride, —H, C₁₋₁₈ alkyl, —(CH₂)ₐ—CH₃, aminoalkyl, —(CH₂)_{b}NH₂, hydroxyl, —OH, and mixtures thereof.

8. The composition of claim 1, wherein the polysiloxane comprises repeating groups —[SiRR′—O]—, wherein R and R′ are each independently selected from the group consisting of hydrogen, —H, C₁₋₁₈ alkyl, —(CH₂)ᵣ—CH₃, methyl, —CH₃, ethyl, —CH₂—CH₃, hydroxyalkoxyalkyl, —(CH₂)ₛ(O(CH₂)ₜ)ᵤ—OH, phenyl, Ph, —(CH₂)ᵥCH(Me)-Ph, and mixtures thereof,
wherein r=0 to 17, and s, t, u, and v each independently are 0 to 5.

9. The composition of claim 1, wherein the polysiloxane comprises repeating groups —[SiRR′—O]—, wherein R and R′ are each independently selected from the group consisting of hydrogen, —H, C₁₋₁₈ alkyl, —(CH₂)ᵣ—CH₃, —(CH₂)ᵥ—CH(Me)-Ph, and mixtures thereof,
wherein r=0 to 17, and v=0 to 5.

10. Silicone-treated lignocellulose particles for use in preparing a lignocellulose composite product, comprising
(a) about 40 wt % to about 99 wt % of lignocellulose particles and
(b) about 0.1 wt % to about 60 wt % of the composition of claim 1.

11. A composition comprising:
(a) about 5 wt % to about 95 wt % of a vegetable C₁₋₄ alkyl ester; and
(b) about 5 wt % to about 95 wt % of a binder resin.

12. The composition of claim 11, wherein the C₁₋₄ alkyl is methyl.

13. The composition of claim 11, wherein the vegetable methyl ester is selected from the group consisting of avocado methyl ester, canola methyl ester, coconut methyl ester, corn methyl ester, cottonseed methyl ester, flaxseed methyl ester, grape seed methyl ester, hemp seed methyl ester, linseed methyl ester, olive methyl ester, palm methyl ester, peanut methyl ester, safflower methyl ester, soybean methyl ester, sunflower methyl ester, and mixtures thereof.

14. The composition of claim 11, wherein the binder resin is selected from the group consisting of polymeric methylenediphenyl diisocyanate, PMDI, phenol formaldehyde, PF, urea formaldehyde, UF, melamine urea formaldehyde, MUF, and mixtures thereof.

15. The composition of claim 11, wherein the binder resin is polymeric methylenediphenyl diisocyanate or PMDI.

16. The composition of claim 11, further comprising:
(c) about 5 wt % to about 95 wt % of a polysiloxane.

17. The composition of claim 16, wherein the polysiloxane are terminated with one or more ligands selected from the group consisting of hydride, —H, halide, Cl, Br, C₁₋₁₈ alkyl, —(CH₂)ₐ—CH₃, aminoalkyl, —(CH₂)_{b}NH₂, hydroxyl, —OH, vinyl, —CH═CH₂, glycidyl ether, —(CH₂)_{c}—O—(CH₂)_{d}—OH, —(CH₂)ₑ—O—(CH₂)_{f}-cyclo(C₂H₃O), epoxycyclohexylethyl, —(CH₂)₂—(C₆H₉O), acrylamidoalkyl, —(CH₂)_{g}N—CO—CH═CH₂, and mixtures thereof;
wherein a =0 to 17; and
b, c, d, e, f and g each independently are 0 to 3.

18. The composition of claim 16, wherein the polysiloxane comprises repeating groups —[SiRR′—O]—, wherein R and R′ are each independently selected from the group consisting of hydrogen, —H, C₁₋₁₈ alkyl, —(CH₂)ᵣ—CH₃, methyl, —CH₃, -ethyl, —CH₂—CH₃, hydroxypolyalkoxyalkyl, —(CH₂)ₛ—(O(CH₂)ₜ)ᵤ—OH, phenyl, Ph, —(CH₂)ᵥ—CH(Me)-Ph, and mixtures thereof,
wherein r=0 to 17, and s, t, u, and v each independently are 0 to 5.

19. A lignocellulose composite product comprising:
(a) about 80 wt % to about 98 wt % of lignocellulose particles, and
(b) about 2 wt % to about 20 wt % of composition of claim 16.
